(19) United States
(12) Patent Application Publication
(10) Pub. No.: US 2024/0425414 A1
(43) Pub. Date: Dec. 26, 2024

(54) EXTREMELY DURABLE CONCRETE (EDC) BASED ON TIRE-DERIVED RUBBER AND LOW-CARBON DURABLE BINDER

(71) Applicants: The Regents of the University of Michigan, Ann Arbor, MI (US); Georgia Tech Research Corporation, Atlanta, GA (US)

(72) Inventors: Victor C. LI, Ann Arbor, MI (US); Duo ZHANG, Ann Arbor, MI (US); Kimberly KURTIS, Atlanta, GA (US)

(73) Assignees: The Regents of The University of Michigan, Ann Arbor, MI (US); Georgia Tech Research Corporation, Atlanta, GA (US)

(21) Appl. No.: 18/750,329

(22) Filed: Jun. 21, 2024

Related U.S. Application Data
(60) Provisional application No. 63/522,880, filed on Jun. 23, 2023.

(51) Int. Cl. C04B 28/04; C04B 14/06; C04B 14/10; C04B 14/28; C04B 16/06; C04B 18/08; C04B 18/22; C04B 24/38; C04B 103/32

(52) U.S. Cl. CPC C04B 28/04; C04B 14/062; C04B 14/106; C04B 14/28; C04B 16/0625; C04B 18/08; C04B 18/22; C04B 24/383; C04B 2103/32; C04B 2201/50

(57) ABSTRACT

An engineered cementitious composite (ECC) that forms extremely durable concrete (EDC) is provide that includes Portland cement binder, a tire-derived rubber granular component (e.g., crumb rubber), a calcined clay component comprising a calcined clay, Portland cement component, and limestone, water, a superplasticizer, a polymeric or natural fiber, and optionally further including silica sand, microsilica, fly ash, a cellulose-based viscosity modifier, microsilica, or combinations thereof. Such an engineered cementitious composite has a tensile strain capacity of greater than or equal to about 3% and an ultimate tensile strength of greater than or equal to about 2.2 MPa. Such an ECC has high toughness and can be loaded in both tension and compression having a built-in capability of crack width control without the need for steel reinforcement.

### CROSS-REFERENCE TO RELATED APPLICATIONS

This application claims the benefit of U.S. Provisional Application No. 63/522,880, filed Jun. 23, 2023. The entire disclosure of the above application is incorporated herein by reference.

### GOVERNMENT SUPPORT

This invention was made with government support under DE-AR0001141 awarded by the Department of Energy. The Government has certain rights in the invention.

### FIELD

The present disclosure relates to engineered cementitious composite materials that form extremely durable concrete and contain a tire-derived rubber and a low carbon binder component.

### BACKGROUND

This section provides background information related to the present disclosure which is not necessarily prior art.

Concrete is the world's most used construction material, and the steadily increasing demand in the construction industry is expected to continue in the next decades. The concrete industry consumes an enormous amount of energy and natural resources while generating substantial emissions. It is ubiquitous in infrastructures, such as buildings, roads, bridges, ports, power supplies, municipal sewer systems, and the like. A primary ingredient for making concrete, ordinary Portland cement (PC) has a high energy intensity and accounts for approximately 5% to 8% of anthropogenic carbon dioxide (CO₂) emissions through its global production. Thus, taking effective actions to curb concrete emissions remains an important objective. Moreover, concrete is strong in compression but weak in tension. The intrinsic brittleness makes concrete vulnerable to cracking. In the field, large cracks create short pathways to facilitate the ingress of harmful species, such as chloride and sulfate, thus accelerating the interior damage and incurring the corrosion of embedded steel reinforcements.

Aging infrastructure systems require repeated shutdowns and repair that incur staggering carbon emissions and energy consumption. In fact, operational and maintenance (O&M) emissions can contribute more than 50% of lifecycle emissions and therefore must be taken into consideration in the next wave of infrastructural renewal.

Given the high energy intensity and carbon emissions of concrete material, extensive research has been conducted to develop green concrete to reduce the environmental impact of concrete/cement, ranging from production efficiency and the material itself. Significant efforts have been made to develop green concrete with low carbon emissions. Among common strategies, reducing the PC usage via partial substitution with supplementary cementitious material (SCM) has proven to be effective. The pozzolanic reaction between the silicates in SCMs and calcium hydroxide in PC's hydration products provides an additional cementing ability that can lead to a concrete strength comparable to a composition that uses only PC. Several industrial waste streams, such as fly ash and ground granulated blast furnace slag (GGBFS), have demonstrated outstanding pozzolanic reactivities and have been incorporated successfully into concrete formulations. Nevertheless, as their upstream industries evolve, the continuing supply of quality SCMs becomes uncertain, thus raising the concern on the sustained production of concrete made with these SCMs.

An example is the declining supply of fly ash. Fly ash is a byproduct generated during coal combustion. As less coal is being burned for energy generation, fly ash supply is diminishing. Besides the challenge of emission reduction during concrete production, the undesirable durability performance of modern concrete structures poses an additional hurdle to sustainability.

Despite the lowered energy consumption and carbon emissions, current green concrete cannot ensure sustainability from the viewpoint of the infrastructure life cycle. As noted above, concrete, including more environmentally friendly variations, is a brittle material and vulnerable to cracking due to mechanical loading, especially during service, and due to restrained deformation caused by shrinkage, corrosion of rebars, sulfate attack, and alkali-silica reactions. Concrete cracking may lead to a variety of deterioration in concrete infrastructures. It directly impairs the mechanical properties of concrete and accelerates structural deterioration. The cracks provide the pathway for aggressive agents to corrode concrete compositions as well as the steel reinforcement bars inside. Research shows that the durability of concrete infrastructures is correlated with the crack width. Unfortunately, despite the awareness of the critical role of cracks in concrete durability, there remains a gap of technologies on how to control crack width effectively.

Thus, it would be desirable to develop new cementitious compositions that reduce emissions while enhancing long-term performance of the structures in which they are incorporated.

### SUMMARY

This section provides a general summary of the disclosure, and is not a comprehensive disclosure of its full scope or all of its features.

In certain aspects the present disclosure relates to an engineered cementitious composite. The engineered cementitious composite comprises a Portland cement binder, a tire-derived rubber granular component, a calcined clay component comprising a calcined clay, Portland cement component, and limestone, water, a superplasticizer, and a polymeric or natural fiber. The engineered cementitious composite having a tensile strain capacity of greater than or equal to about 3% and an ultimate tensile strength of greater than or equal to about 2.2 MPa.

In one aspect, the Portland cement binder is present at greater than or equal to about 20% by mass to less than or equal to about 26% by mass of the engineered cementitious composite.

In one further aspect, the Portland cement binder is present at greater than or equal to about 21% by mass to less than or equal to about 24% by mass of the engineered cementitious composite.

In one aspect, the calcined clay component is present at greater than or equal to about 9% by mass to less than or equal to about 15% by mass of the engineered cementitious composite.

In one aspect, the calcined clay component is present at greater than or equal to about 10.7% by mass to less than or equal to about 11.8% by mass of the engineered cementitious composite.

In one aspect, the calcined clay comprises a metakaolin.

In one further aspect, the calcined clay component has a mass ratio of calcined clay to limestone of about 1:1.

In one aspect, the tire-derived rubber granular component is present at greater than or equal to about 1.8% by mass to less than or equal to about 23% by mass of the engineered cementitious composite.

In one aspect, the tire-derived rubber granular component is present at greater than or equal to about 5.6% by mass to less than or equal to about 14.5% by mass of the engineered cementitious composite.

In one aspect, the tire-derived rubber granular component is a plurality of particles having an average particle size of greater than or equal to about 50 micrometers to less than or equal to about 200 micrometers.

In one aspect, the superplasticizer is present at greater than or equal to about 0.26% to less than or equal to about 0.33% by the mass of engineered cementitious composite.

In one aspect, the polymeric or natural fiber comprises polyalkylene fibers present at greater than 1 volume % to less than or equal to about 3 volume % of the engineered cementitious composite.

In one aspect, the water is present at present at greater than or equal to about 19% by mass to less than or equal to about 31% by mass and the superplasticizer is present at greater than or equal to about 0.26% to less than or equal to about 0.33% by the mass of engineered cementitious composite.

In one aspect, the engineered cementitious composite further comprises an additive selected from the group consisting of: silica sand, fly ash, a cellulose-based viscosity modifier, microsilica, and combinations thereof.

In one aspect, the engineered cementitious composite further comprises an additive selected from the group consisting of: silica sand present at greater than 0% by mass to less than or equal to about 17% by mass of the engineered cementitious composite, fly ash present at greater than 0% by mass to less than or equal to about 40% by mass of the engineered cementitious composite, a cellulose-based viscosity modifier present at greater than 0.05% to less than or equal to about 0.1% by mass of binders present in the engineered cementitious composite, wherein the binders comprise the Portland cement binder, the calcined clay component, and any fly ash, microsilica present at greater than 0% by mass to less than or equal to about 5% by mass of the engineered cementitious composite, and combinations thereof.

In certain further aspects, the present disclosure relates to an engineered cementitious composite comprising Portland cement binder at greater than or equal to about 20% by mass to less than or equal to about 26% by mass of the engineered cementitious composite, a tire-derived rubber granular component at greater than or equal to about 1.8% by mass to less than or equal to about 23% by mass of the engineered cementitious composite, a calcined clay component comprising a calcined clay, Portland cement component, and limestone at greater than or equal to about 9% by mass to less than or equal to about 15% by mass of the engineered cementitious composite, water at greater than or equal to about 19% by mass to less than or equal to about 31% by mass, a superplasticizer at greater than or equal to about 0.26 to less than or equal to about 0.33% by the mass of engineered cementitious composite, and a polymeric or natural fiber at greater than or equal to about 1% by volume to less than or equal to about 2% by volume. The engineered cementitious composite has a tensile strain capacity of greater than or equal to about 3% and an ultimate tensile strength of greater than or equal to about 2.2 MPa.

In one aspect, the engineered cementitious composite further comprises an additive selected from the group consisting of: silica sand, fly ash, a cellulose-based viscosity modifier, microsilica, and combinations thereof.

In one aspect, the engineered cementitious composite further comprises an additive selected from the group consisting of: silica sand present at greater than 0% by mass to less than or equal to about 17% by mass of the engineered cementitious composite, fly ash present at greater than 0% by mass to less than or equal to about 40% by mass of the engineered cementitious composite, a cellulose-based viscosity modifier present at greater than 0.05% to less than or equal to about 0.1% by mass of binders present in the engineered cementitious composite, wherein the binders comprise the Portland cement, the calcined clay component, and any fly ash, microsilica present at greater than 0% by mass to less than or equal to about 5% by mass of the engineered cementitious composite, and combinations thereof.

In one aspect, the calcined clay component has a mass ratio of calcined clay to limestone of about 1:1 and the calcined clay comprises a metakaolin.

In one aspect, the tire-derived granular rubber component is a plurality of tire-derived particles having an average particles size of greater than or equal to about 50 micrometers to less than or equal to about 200 micrometers.

In yet further aspects, the present disclosure relates to an engineered cementitious composite comprising a Portland cement binder at greater than or equal to about 21% by mass to less than or equal to about 24% by mass of the engineered cementitious composite, a tire-derived rubber granular component at greater than or equal to about 5% by mass to less than or equal to about 15% by mass of the engineered cementitious composite, a calcined clay component comprising a calcined clay, a Portland cement binder, and limestone at greater than or equal to about 10% by mass to less than or equal to about 12% by mass of the engineered cementitious composite, water at greater than or equal to about 27% by mass to less than or equal to about 31% by mass, a superplasticizer at greater than or equal to about 0.26% to less than or equal to about 0.33% by the mass of engineered cementitious composite, a polymeric or natural fiber at greater than or equal to about 1% by volume to less than or equal to about 2% by volume, silica sand present at greater than 0% by mass to less than or equal to about 17% by mass of the engineered cementitious composite, microsilica present at greater than 0% by mass to less than or equal to about 5% by mass of the engineered cementitious composite, fly ash present at greater than 14% by mass to less than or equal to about 30% by mass of the engineered cementitious composite, a cellulose-based viscosity modifier present at greater than 0.05% to less than or equal to about 0.1% by mass of binders present in the engineered cementitious composite, wherein the binders comprise the Portland cement binder, the calcined clay component, and the fly ash. The engineered cementitious composite has a tensile strain capacity of greater than or equal to about 7% and an ultimate tensile strength of greater than or equal to about 3.5 MPa.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIGS. 1A-1C show enhancement of crack width control by inclusion of tire-derive crumb rubber in an engineered cementitious composite (ECC) material in terms of the σ−δ relationship, where a. FIG. 1A shows a weakened matrix, while FIG. 1B shows a comparison of a cementitious composition comprising a fiber, a cementitious composition comprising a tire-derived crumb rubber component, and a cementitious composition comprising both the fiber and the tire-derived crumb rubber component.

FIG. 1C shows how crumb rubber inclusion at different volumes (substitution percentages of fly ash) in an engineered cementitious composite reduced fracture toughness Kₘ(MPa \sqrt{m}).

FIGS. 2A-2B show scanning electron microscopy (SEM) images of silica sand (FIG. 2A) and tire-derived crumb rubber particles (FIG. 2B).

FIGS. 3A-3B show mechanical testing of engineered cementitious composite compositions. FIG. 3A shows a dogbone-shaped specimen for uniaxial tension test with dimensions. FIG. 3B shows a setup for testing.

FIGS. 4A-4C show uniaxial tension test set-up and specimen's dimension for an in-situ micro-CT experiment. In FIG. 4A, a uniaxial tension test set-up in load cell is shown. In FIG. 4B, a specimen's dimension in mm is shown. In FIG. 4C, a 3D-printed mold's dimensions in mm is shown.

FIG. 5 show a setup for a micro-CT test.

FIGS. 6A-6B show tensile stress-strain relation (FIG. 6A) and crack width evolution (FIG. 6B) for an example of an engineered cementitious composite (ECC) composition prepared in accordance with certain aspects of the present disclosure containing a tire-derived crumb rubber (CR) and a control ECC without any CR.

FIGS. 7A-7B show SEM images of rubber particles linking cracks in an engineered cementitious composite composition. FIG. 7A has a scale bar of 20 micrometers (μm) and FIG. 7B is a magnified view with a scale bar of 10 μm.

FIGS. 8A-8B show two-dimensional (2D) slices of reconstructed images (7.2×3.2 mm²) for two regions of interest (ROIs) (crack scatterings around the crumb rubber were observed as marked by the circles).

FIG. 9 shows a stress (σ)-strain (ε) relationship between the in-situ tension test and the micro-CT scans.

FIGS. 10A-10E show different 2D μCT slices acquired during the in-situ uniaxial tensile test (image size: 2.3×6.4 mm²) corresponding to the points shown in FIG. 9.

FIGS. 11A-11D show the tire-derived crumb rubber (CR) bridging processes. FIG. 11A shows before any matrix cracking appears. FIG. 11B shows a matrix crack with CR intercepts and bridges crack faces. FIG. 11C shows stretching of CR across the crack opening. FIG. 11D shows ruptured CR particles (image size: 1.6×1 mm²).

FIG. 12 shows a cylindrical shape representative of a simplified tire-derived crumb rubber particle.

FIG. 13 shows a particle size distribution and fit curve.

FIGS. 14A-14B show a relationship between stress and crack opening.

FIG. 14A shows stress (MPa) versus crack opening width (μm) for an engineered cementitious composite (ECC) composition with a fiber, an ECC with a tire-derived crumb rubber (CR), and an ECC with both a fiber and CR. FIG. 14B shows crack opening width (μm) versus stress (MPa) for an engineered cementitious composite (ECC) composition with a fiber, an ECC with both a fiber and CR, and crack width reduction.

FIG. 15 shows a typical fiber bridging stress-crack opening (σ−δ).

FIG. 16 shows tensile stress-strain relations with tire-derived crumb rubber (CR) content.

FIG. 17 shows a tire-derived crumb rubber (CR) particle bridging stress with different amounts of fly ash (FA) replaced by CR (as indicated).

FIGS. 18A-18B show a relationship between stress and crack opening for ECC with different a tire-derived crumb rubber (CR) content. FIG. 18A shows stress (MPa) versus crack opening width (μm) for an engineered cementitious composite (ECC) composition with varying amounts of CR. FIG. 14B shows crack opening width (μm) versus stress (MPa) for an engineered cementitious composite (ECC) composition with varying CR content.

FIG. 19 show a comparison of predicted and measured crack width reduction.

FIG. 20 shows a tire-derived crumb rubber (CR) particle bridging stress (MPa) versus crack opening width (μm) of varying rubber particle size distribution.

FIGS. 21A-21B show stress-crack opening curves and crack width reduction of varying rubber particle size distribution. In FIG. 21A, stress (MPa) versus crack opening width (μm) for different engineered cementitious composite (ECC) compositions with different sizes of a tire-derived crumb rubber (CR) are shown. FIG. 21B shows crack opening width reduction (%) versus stress (MPa) for these ECC compositions.

FIG. 22 shows a tire-derived crumb rubber (CR) particle bridging stress (MPa) of varying rubber elongation (ε_{CR}^{c}).

FIGS. 23A-23B show stress-crack opening curve and crack width reduction of varying rubber elongation (ε_{CR}^{c}). FIG. 23A shows stress (MPa) versus crack opening width (μm) for an engineered cementitious composite (ECC) composition tire-derived crumb rubber (CR) having different elongation amounts. FIG. 23B shows crack opening width (μm) versus stress (MPa) in the pre-peak portion of the σ−δ relation.

FIG. 24 shows a tire-derived crumb rubber (CR) particle bridging stress of varying α.

FIGS. 25A-25B show stress-crack opening curve and crack width reduction of varying α. FIG. 25A shows stress (MPa) versus crack opening width (μm) for an engineered cementitious composite (ECC) composition tire-derived crumb rubber (CR) having different α. FIG. 25B shows crack width reduction (%) versus stress (MPa) in the pre-peak portion of the σ−δ relation.

FIG. 26 shows a tire-derived crumb rubber (CR) particle bridging stress of varying β.

FIGS. 27A-27B show stress-crack opening curve and crack width reduction of varying β. FIG. 27A shows stress (MPa) versus crack opening width (μm) for an engineered cementitious composite (ECC) composition tire-derived crumb rubber (CR) having different β. FIG. 27B shows crack width reduction (%) versus stress (MPa) for an engineered cementitious composite (ECC) composition in the pre-peak portion of the σ−δ relation for varying β levels.

FIG. 28 shows a tire-derived crumb rubber (CR) particle bridging stress (MPa) versus crack opening width (μm) with varying γ.

FIGS. 29A-29B show stress-crack opening curve and crack width reduction of varying γ. FIG. 29A shows stress (MPa) versus crack opening width (μm) for an engineered cementitious composite (ECC) composition tire-derived crumb rubber (CR) having different γ. FIG. 29B shows crack width reduction (%) versus stress (MPa) for an engineered cementitious composite (ECC) composition for varying γ levels.

Corresponding reference numerals indicate corresponding parts throughout the several views of the drawings.

### DETAILED DESCRIPTION

Example embodiments are provided so that this disclosure will be thorough, and will fully convey the scope to those who are skilled in the art. Numerous specific details are set forth such as examples of specific compositions, components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, elements, compositions, steps, integers, operations, and/or components, but do not preclude the presence or addition of one or more other features, integers, steps, operations, elements, components, and/or groups thereof. Although the open-ended term “comprising,” is to be understood as a non-restrictive term used to describe and claim various embodiments set forth herein, in certain aspects, the term may alternatively be understood to instead be a more limiting and restrictive term, such as “consisting of” or “consisting essentially of.” Thus, for any given embodiment reciting compositions, materials, components, elements, features, integers, operations, and/or process steps, the present disclosure also specifically includes embodiments consisting of, or consisting essentially of, such recited compositions, materials, components, elements, features, integers, operations, and/or process steps. In the case of “consisting of,” the alternative embodiment excludes any additional compositions, materials, components, elements, features, integers, operations, and/or process steps, while in the case of “consisting essentially of,” any additional compositions, materials, components, elements, features, integers, operations, and/or process steps that materially affect the basic and novel characteristics are excluded from such an embodiment, but any compositions, materials, components, elements, features, integers, operations, and/or process steps that do not materially affect the basic and novel characteristics can be included in the embodiment.

Any method steps, processes, and operations described herein are not to be construed as necessarily requiring their performance in the particular order discussed or illustrated, unless specifically identified as an order of performance. It is also to be understood that additional or alternative steps may be employed, unless otherwise indicated.

When a component, element, or layer is referred to as being “on,” “engaged to,” “connected to,” or “coupled to” another element or layer, it may be directly on, engaged, connected or coupled to the other component, element, or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various steps, elements, components, regions, layers and/or sections, these steps, elements, components, regions, layers and/or sections should not be limited by these terms, unless otherwise indicated. These terms may be only used to distinguish one step, element, component, region, layer or section from another step, element, component, region, layer or section. Terms such as “first,” “second,” and other numerical terms when used herein do not imply a sequence or order unless clearly indicated by the context. Thus, a first step, element, component, region, layer or section discussed below could be termed a second step, element, component, region, layer or section without departing from the teachings of the example embodiments.

Spatially or temporally relative terms, such as “before,” “after,” “inner,” “outer,” “beneath,” “below,” “lower,” “above,” “upper,” and the like, may be used herein for ease of description to describe one element or feature's relationship to another element(s) or feature(s) as illustrated in the figures. Spatially or temporally relative terms may be intended to encompass different orientations of the device or system in use or operation in addition to the orientation depicted in the figures.

Throughout this disclosure, the numerical values represent approximate measures or limits to ranges to encompass minor deviations from the given values and embodiments having about the value mentioned as well as those having exactly the value mentioned. Other than in the working examples provided at the end of the detailed description, all numerical values of parameters (e.g., of quantities or conditions) in this specification, including the appended claims, are to be understood as being modified in all instances by the term “about” whether or not “about” actually appears before the numerical value. “About” indicates that the stated numerical value allows some slight imprecision (with some approach to exactness in the value; approximately or reasonably close to the value; nearly). If the imprecision provided by “about” is not otherwise understood in the art with this ordinary meaning, then “about” as used herein indicates at least variations that may arise from ordinary methods of measuring and using such parameters. For example, “about” may comprise a variation of less than or equal to 5%, optionally less than or equal to 4%, optionally less than or equal to 3%, optionally less than or equal to 2%, optionally less than or equal to 1%, optionally less than or equal to 0.5%, and in certain aspects, optionally less than or equal to 0.1%.

In addition, disclosure of ranges includes disclosure of all values and further divided ranges within the entire range, including endpoints and sub-ranges given for the ranges.

As used herein, unless otherwise indicated, amounts expressed in weight and mass are used interchangeably, but should be understood to reflect a mass of a given component.

As used herein, the terms “composition” and “material” are used interchangeably to refer broadly to a substance containing at least the preferred chemical constituents, elements, or compounds, but which may also comprise additional elements, compounds, or substances, including trace amounts of impurities, unless otherwise indicated.

Example embodiments will now be described more fully with reference to the accompanying drawings.

The present disclosure provides new cementitious materials that use waste tire rubber, incorporated as a tire-derived component, into an extremely durable concrete (EDC) that is an engineered cementitious composite (ECC) material. This cementitious material provides a class of low-energy, low-carbon, and rubber-modified ductile cementitious composite materials having in certain variations a tensile strain capacity over 3%, i.e., 300 times that of conventional concrete, and an intrinsic crack width less than 50 micrometers (μm), irrespective of the imposed stress or strain.

Waste tire rubber is a significantly under-utilized resource and an increasing burden to the environment. The auto industry produces a large volume of waste tires that require safe recycling and reutilization. Unfortunately, the market growth of recycled tires has been stagnant, due to the limited end-use applications of this material. The concrete industry can potentially provide a viable solution by utilizing materials from waste tires as a raw ingredient or tire-derived component in concrete. By “tire-derived component,” it is meant that a material is derived from waste tires, for example, comprising natural rubber or synthetic rubbers or elastomers, such as butadiene rubber, styrene butadiene rubber, halogenated polyisobutylene rubber, and the like. The polymer may be further reinforced with particles, such as carbon black, silica, and the like. The tire-derived component may be processed, for example, by separating metal and tire cord from the rubber, followed by mechanical processing, such as cutting, chipping, granulating, and the like to form a plurality of relatively small granules or particles, also known as crumbs. For example, the tire-derived granular component may be formed from tires ground at low temperatures, for example, having approximately 25 to 35% carbon black, polymer rubber hydrocarbon content (RHC) of greater than or equal to about 42%, and a metal content of less than or equal to about 0.1%. When a tire-derived component is included in a granular or crumb rubber form in particular, enhancements in concrete lightweightedness and thermal insulation can occur. Improving the rubber surface hydrophilicity via surface treatment can further enhance the concrete compressive and flexural strength. Nevertheless, the intrinsic brittle nature of concrete remains a bottleneck in the mechanical and durability performance of crumb rubber-doped concrete.

Unlike prior use of crumb rubber in concrete, the present technology involves new concrete compositions that incorporate tire-derived crumb granular rubber as a component in combination with other ingredients that lead to improvements in performance, including extreme tensile ductility and durability. While tire-derived granular crumb rubber serves to address artificial flaws to induce high tensile ductility, it was unexpectedly discovered in conjunction with the inventive activities that led to the present application that the tire-derived crumb rubber granular component in such compositions further leads to tightened crack width. The present technology thus addresses the collective urgency for sustainable development of the concrete and auto industries, by turning waste rubber powders into an extremely durable concrete material with robust crack control and self-healing capability. For example, the tire-derived crumb granular rubber controls concrete crack width. By coupling a durable binder chemistry with robust microfiber bridging, it was found that tire-derived granules or crumb rubber can unexpectedly limit concrete crack width to an unprecedentedly small level, while maintaining an ultrahigh concrete tensile ductility.

By way of background, engineered cementitious composites (ECC) are an ultra-ductile class of fiber-reinforced cementitious composite (FRCC). Typical ECCs have high tensile ductility and develop tensile strain capacities higher than 3%. Compared to conventional concrete, which tension-softens after cracking, ECC exhibits tension-hardening, which means it can sustain and transfer load even after cracking due to fiber bridging. The crack width of conventional concrete is at the mm level, while ECC shows a much smaller crack width typically around or less than 100 micrometers (μm) during the strain-hardening stage. Under uniaxial tension, ECC forms multiple fine cracks by increasing the number of cracks instead of crack width. The tight cracks (typically below 100 micrometers (μm) in width) continue carrying load(s) via microfiber bridging. This intrinsic capability of crack width control limits material permeability in loaded conditions even beyond the elastic state and improves material self-healing and structural durability.

However, the mechanical properties of ECC depend on the properties of fiber, matrix, and interface. The material design of ECC may be established on micromechanical principles by tailoring the properties of the matrix, fiber, and fiber/matrix interface. Among polymeric fibers that can be used in ECC, polypropylene (PP) fiber has a relatively low cost and is attractive for large-scale applications. PP fiber has been successfully used in ECC, as has a high-tenacity (defined as the fiber breaking force divided by the linear mass density, i.e., denier) PP (HTPP) fiber, or poly(vinyl) alcohol (PVA) fiber. Although the high tensile ductility and robust crack width control of the ECC material can be achieved in the design phase, the actual material processing often leads to high variability in these properties. A potential source of this variability is the fiber distribution in the cementitious matrix. It is believed that the viscosity of the mortar matrix can tailor the fiber dispersion. For ECC compositions incorporating hydrophilic fibers, such as PVA and basalt fiber, the crack width of ECC can be maintained at a low level due to the strong bonding of the fiber/matrix. In contrast, the crack width seems much larger for that made of hydrophobic fiber (PP and PE) with the absence of chemical bonding of fiber/matrix. The crack width control ability of such ECCs needs to be improved to ensure the extreme durability of infrastructures.

As will be described further below, the cementitious compositions of the present disclosure may comprise fibers, a tire-derived component, like crumb rubber particles, and a calcined clay component, such as limestone calcined clay cement (LC3). Limestone calcined clay cement (LC3) has received increasing attention for its low environmental footprint and enhanced durability. The coupled use of limestone and calcined kaolinite-containing clays, where kaolinite comprises at least 40% of the clay, enables a high clinker substitution as an efficient pozzolan in cementitious materials. LC3 can be incorporated into ECC, such as a PP fiber-ECC, that can provide robust self-healing capability and crack control while reducing a carbon footprint of the material as compared to conventional ECC based on Portland cement. LC3 has a different rheology from conventional ordinary Portland cement. The mortar and concrete made with LC3 show reduced workability, higher demand for superplasticizer, and lower slump retention over time. The rheological distinction between LC3 and conventional Portland cement binders has not been previously considered in designing PP-ECC to enhance fiber bridging efficiency.

While the relationship among matrix rheology, fiber (e.g., PVA) dispersion, and ECC composite properties have been well established, such relationships for ECC reinforced with high aspect ratio hydrophobic PP fibers has been unclear. As PP fibers are low-cost but difficult to disperse, clarifying these relations for PP-ECC will help material design and quality control that may accelerate ECC's tech-to-market transitions to realize lifecycle emission reduction. In this regard, having a better understanding of the effect of matrix rheology on fiber dispersion, such as PP fiber dispersion, and to correlate the matrix plastic viscosity to the composite fresh and mechanical properties would be advantageous. Moreover, an optimal range of matrix viscosity controlled by the dosage of viscosity modifying admixture identified for PP-ECC is important. The present disclosure thus contemplates improved quality control of low-carbon, low-cost, ECC cementitious materials having enhanced fiber dispersion.

Importantly, in addition to fibers, the compositions provided by the present disclosure include a calcined clay component and a tire-derived granular component, in addition to the other components described herein. First, a low-carbon cementitious matrix is developed by proportioning a small content of a calcined clay component, such as the LC3 described above, that comprises a calcined clay, a Portland cement component that may be an ordinary Portland cement clinker or ordinary Portland cement product, and limestone. Notably, the Portland cement component in the calcined clay component is distinct from any ordinary Portland cement used as a primary binder or matrix in the composition. The calcined clay may include a low-purity calcined clay, such as a kaolinite that is transformed to a metakaolin after calcination. The calcined clay component may also comprise a limestone powder and an ordinary Portland cement component. The limestone particles may have an average particle size of about 40 micrometers in certain variations and thus serves as a microfiller in the ECC composition. Such a calcined clay limestone cement (LC3) is considered to be a green or environmentally friendly cementitious minder, because a much higher level of clinker is substituted by the calcined clay and limestone, resulting in a significant reduction in both the cost and the environmental impact of the material, but remaining relatively comparable in other properties to ordinary Portland cement.

In certain aspects, the calcined clay component is present at greater than or equal to about 9% by mass to less than or equal to about 15% by mass of the engineered cementitious composite, optionally at greater than or equal to about 10% by mass to less than or equal to about 13% by mass, and in certain variations, optionally at greater than or equal to about 10.7% by mass to less than or equal to about 11.8% by mass of the engineered cementitious composite. In certain variations, the calcined clay component has a mass ratio of calcined clay (e.g., metakaolin) to limestone of about 1:1. In certain aspects, the calcined clay component may have a “low purity,” where it is mainly comprised of metakaolin, which is produced from kaolinite calcination. The low purity allows the use of local clay for metakaolin production. In certain variations, kaolinite comprises greater than or equal to about 40% of the calcined clay component. The clay comprising kaolinite may be calcined in a conventional manner, for example, being calcined in a flash calciner or clinker kiln at temperatures of greater than or equal to about 600 to less than or equal to about 800° C., by way of example. The limestone particles or powder may have a composition of greater than or equal to about 95% by mass of calcium carbonate (CaCO₃). In certain variations, the limestone particles may have a mean particle size of greater than or equal to about 3 micrometers (μm) to less than or equal to about 25 μm.

The second main component is a tire-derived rubber granular component. Unlike conventional concrete designed for compression only, the rubber-modified ECC/EDC can be loaded in both tension and compression and embodies a built-in capability of crack width control without the need for steel reinforcement. The tire-derived waste rubber component plays a unique role in amplifying this unique capability. The cementitious (e.g., ECC/EDC) composite composition according to various aspects of the present disclosure is designed based on microfiber bridging and forms multiple fine cracks instead of a single wide crack to accommodate the imposed strain. The composite synergizes the design of rubber-modified calcined clay-based matrix, fiber, and fiber/matrix interface. In certain variations, the cementitious composition comprises the tire-derived rubber granular component at greater than or equal to about 1.8% by mass to less than or equal to about 23% by mass of the engineered cementitious composite, optionally greater than or equal to about 5.6% by mass to less than or equal to about 14.5% by mass of the engineered cementitious composite. In certain variations, the tire-derived rubber granular component is a plurality of particles having an average particle size of greater than or equal to about 50 micrometers (μm) to less than or equal to about 200 μm. The tire-derived granular component particle size may be selected to be relatively close to the particle size of the fly ash and calcined clay component (including the limestone particles). In certain aspects, suitable commercially available tire-derived granular crumb rubber component is MicroDyne 50™ or MicroDyne 75-TR™ both sold by Lehigh. MicroDyne 75-TR™ can be incorporated into the engineered cementitious composite (ECC) composition as partial substitution of the calcined clay component/limestone or fly ash, where present. As will be described further below, the incorporation of the tire-derived granular component imparts artificial flaws in ECC, can control crack width, and when present at predetermined levels, can increase ECC tensile strength and ductility. However, the tire-derived granular component can decrease workability during the fresh state of the ECC as its relative concentration increases. For example, in certain ECC compositions, approximately 30 to 70% substitution levels of the tire-derived component for other cementitious binder materials like the calcined clay component and fly ash enhances the ECC's tensile strength and ductility, while maintaining sufficient workability. In certain variations, ECC crack width decreases (e.g., almost linearly) with an increasing content of a tire-derived granular component, like MicroDyne 75-TR™, as a substitution for the calcined clay component (including limestone.) As described further herein, a total number of cracks in the ECC increases and is amplified by inclusion of the tire-derived granular component. Tighter cracks translate to enhanced material/structural durability and lowered lifecycle emissions when deployed in infrastructure systems.

In certain aspects, while not limiting the present technology to any particular theories, it is believed that the present technology achieves extreme durability of concrete (ECC) materials via three synergistic routes, namely 1) high composite tensile ductility strengthened by the rubber incorporation to accommodate extreme loadings and deformations, 2) tight cracks (minimal crack widths) that maintain a low material permeability when subjected to these loadings, and 3) durable binder chemistry with a high resistance to chemical deteriorations in the uncracked material.

As discussed above, cementitious compositions are contemplated by certain aspects of the present disclosure having a tensile strain capacity of greater than or equal to about 3% and an ultimate tensile strength of greater than or equal to about 2.2 MPa. In certain variations, the composition comprises a Portland cement binder, a calcined clay component that includes a calcined clay, a Portland cement component, and limestone, a tire-derived rubber granular component, water, a high range water reducing agent (HRWRA) or superplasticizer, and a fiber. The composition may also comprise a fine aggregate, such as silica sand, microsilica, fly ash, a cellulose-based viscosity modifier, and any combinations thereof. It will be appreciated that in certain variations, the composition may consist essentially of or consist of a Portland cement binder, a calcined clay component that includes a calcined clay, a Portland cement component, and limestone, a tire-derived rubber granular component, water, a high range water reducing agent (HRWRA) or superplasticizer, a fiber, and optionally comprise a fine aggregate, such as silica sand, microsilica, fly ash, a cellulose-based viscosity modifier, and any combinations thereof.

The compositions provided by the present disclosure may include a low-carbon cementitious matrix (meaning the ingredients that are cementitious or binders) that includes a small content of Portland cement clinker as a binder, a calcined clay component that include low-purity calcined clay, a limestone powder, and additional ordinary Portland cement component, and other components, like fibers, and an optional silica sand. The initial matrix design is guided by the required grade of compressive strength, in order to satisfy the load-bearing capacity as specified by the end-users. Particle packing density is used as a design indicator to optimize the compressive strength. Second, the cementitious matrix is built with a crack control capability collectively established by microfiber bridging and a tire-derived component (e.g., crumb rubber) incorporation.

Besides microfiber bridging, the tire-derived component in the form of crumb rubber is added in a granular or finely ground form (where the particles have a mean diameter of greater than or equal to about 50 micrometers to less than or equal to about 200 micrometers) and may be uniformly or homogeneously mixed into cementitious matrix. Such a granular tire-derived crumb rubber appears to have a role in two aspects, 1) modifying the toughness of cementitious matrix, and 2) limiting the opening of microcracks. In the first aspect, a volumetric dosage of crumb rubber is controlled by the relationships among the initial matrix toughness, complimentary energy, first-cracking strength, and fiber bridging capability. Crumb rubber is used to tailor the matrix toughness and first-cracking strength to improve the margins with respect to the complimentary energy and fiber bridging capability, respectively. In the second aspect, crumb rubber is perceived to bridge microcracks during the early stage of crack initiation. The deformation of rubber particles across microcracks tends to absorb energy in the crack opening process and contributes to crack width control together with microfibers.

Examples for fibers, such as microfibers, include polymeric fibers, such as poly(vinyl) alcohol (PVA) and polyalkylene fibers, such as polypropylene (PP) and polyethylene (PE), including high tenacity polypropylene (HTPP) fibers, and natural plant fibers, such as bamboo, sisal, jute, curaua fibers, and/or cellulose-based fibers, and the like. In certain variations, the polymeric fibers may be oil coated. The oil coating may be greater than or equal to about 1 to less than or equal to about 1.5% by mass, for example, about 1.2% by mass, of the total mass/weight of the fiber and oil coating combined.

In certain variations, a fiber used in the cementitious composition has a length of greater than or equal to about 4 mm to less than or equal to about 20 mm, optionally greater than or equal to about 6 mm to less than or equal to about 15 mm, and in certain variations, optionally greater than or equal to about 8 mm to less than or equal to about 12 mm. In certain variations, a fiber used in the cementitious composition has a diameter of greater than or equal to about 10 micrometers (μm) to less than or equal to about 200 μm. In one variation, the polymeric fiber is a PP fiber that may have a length of about 12 mm and a diameter of about 12 micrometers. One such chopped PP fiber is commercially available from Saint-Gobain and may have a nominal strength of about 910 MPa, a Young's modulus of 9 GPa, and an elongation of 22%. In another variation, the polymeric fiber is a PP fiber that may have a length of about 18 mm and a diameter of about 24 micrometers. The polymer fiber may be present in the cementitious composition at greater than or equal to about 1 vol. % to less than or equal to about 4.5 vol. % of the total volume of the cementitious composition, optionally at greater than or equal to about 1 vol. % to less than or equal to about 3 vol. %, and in certain variations, optionally at about 2 vol. %. In certain aspects, microfibers in the present compositions can help provide a robust crack bridging capability and control the crack opening process.

In certain variations, a fiber may be a hydrophobic PP fiber. A relationship between PP fiber distribution and the matrix viscosity provides a desirable level of matrix viscosity for ECC's fresh and hardened properties. An optimal range of matrix viscosity exists for maximizing PP-ECC's tensile strain capacity and ultimate tensile strength simultaneously. To enhance fiber bridging capacity of the ECC material, a good dispersion of fibers (e.g., PP fibers) is advantageous, which requires a sufficient level of matrix viscosity. Increasing a matrix viscosity from approximately 1 to 26 Pa·s (at room temperature or about 21° C.) was found to improve PP-ECC fiber dispersion coefficient from 0.43 to 0.85. However, an overly viscous matrix lowers the workability of fresh mixtures, thus reducing the composite tensile strength and ductility by altering the flaw distribution, particularly by entrapping large air voids during mixing. In certain variations, a matrix viscosity in a fresh (uncured) state may be greater than or equal to about 10.3 to less than or equal to about 11.5 Pa·s. In one variation, a matrix plastic viscosity may be about 11 Pa·s for PP fiber, which is lower than that for conventional PVA fiber, (about 7 Pa·s). This leads to matrix deformation factors (T) of 1.4 for PP-ECC without sand and 1.8 for PP-ECC with sand. Matrix deformation factor (T) can serve as a simple indicator of the fresh matrix property related to viscosity and fiber distribution.

The cementitious matrix may comprise an ordinary Portland cement present as a main binder. A Portland cement typically comprises inorganic compounds, such as dicalcium silicate (C₂S or 2CaO·SiO₂), tricalcium silicate (C₃S or 3CaO·SiO₂), tricalcium aluminate (C₃A or 3CaO·Al₂O₃), and tetracalcium aluminoferrite (C₄AF or 4CaO·Al₂O₃·Fe₂O₃), which may be hydrated. Commercially available Portland cement often includes additives, such as gypsum (calcium sulfate) that serves as a set retardant, and pozzolans, like fly ash and ground granulated blast furnace slags (GGBFS), that can react with calcium hydroxide and water to form calcium silicate hydrates or calcium aluminate hydrates. When pozzolans are added to Portland cement, they are considered to be blended cements. ASTM, International Test C 150 called the “Standard Specification for Portland Cement” provides eight types of ordinary Portland cement for different applications, namely: Types I, IA, II, IIA, III, IIIA, IV, and V. In certain non-limiting aspects, the Portland cement used in the cementitious composition is Type I. The Portland cement may be present as a binder in the cementitious composition at greater than or equal to about 20 mass % to less than or equal to about 26 mass % of the total mass of cementitious composition, optionally at greater than or equal to about 21 mass % to less than or equal to about 24 mass % of the total mass of the cementitious composition. It should be noted that the amounts of Portland cement indicated here as a binder are exclusive of and do not include any amounts of Portland cement included as a component in the calcined clay component.

The cementitious composition also includes a high range water reducing agent (HRWRA), also known as a plasticizer/superplasticizer. Inclusion of the HRWRA can serve to reduce water content needed in the cementitious composition by about 10% to about 30%. The HRWRA can create high fluidity with good flowability properties for the cementitious composition, for example, contributing to make the cementitious composition suitable for additive manufacturing or other similar processes by helping to eliminate the need for any vibration or compaction after deposition. An example of a suitable HRWRA is a high-range water-reducing admixture commercially available from BASF as MasterGlenium 7920™ or from W.R. Grace as ADVA® 190. The HRWRA may be present in the cementitious composition at greater than or equal to about 0.26 mass % to less than or equal to about 0.33 mass % of the total mass the engineered cementitious composite and optionally at greater than or equal to about 0.28 mass % to less than or equal to about 0.31 mass % of the total mass of the engineered cementitious composite.

Water is also included in the cementitious composition. A mass ratio of water to cementitious binder components (e.g., Portland cement, calcined clay component, and any other pozzolanic materials, like fly ash) may be greater than or equal to about 0.2 to less than or equal to about 0.3. Water may be present in the cementitious composition at greater than or equal to about 19 mass % to less than or equal to about 31 mass % of the total cementitious composition, optionally at greater than or equal to about at greater than or equal to about 28% by mass to less than or equal to about 31% by mass

In certain variations, the cementitious composition further comprises one or more components selected from the group consisting of: fine aggregate, like silica sand, fly ash, a cellulose-based viscosity modifier, and any combinations thereof.

The cementitious composition also optionally includes a fine aggregate, such as an inert sand or inert finely crushed stone. Fine aggregates have a particle size distribution having approximately 95% passing on a 9.5 mm sieve (⅜ inch sieve). For example, in one variation, the aggregate particles may have an average diameter (D) or D50 (meaning a cumulative 50% point of diameter (or 50% pass particle size)) of greater than or equal to about 50 micrometers (μm) to less than or equal to about 210 μm, for example, on average 110 μm. In certain variations, the fine aggregate is sand. The fine aggregate may be silica sand in certain variations. The solid aggregate is distributed within the cementitious matrix to form a composite. In certain variations, the aggregate may be substantially homogeneously distributed within the cementitious composite (e.g., concrete) that is formed. The fine aggregate may comprise sand that has an average particle size of less than or equal to about 2 mm. In one non-limiting variation, the aggregate may be an F-75 silica or quartz sand commercially available from U.S. Silica. The fine aggregate, such as silica sand, may be present in the cementitious composition at greater than or equal to about 0 mass % to less than or equal to about 17 mass % of the total mass of cementitious composition.

Fly ash can be added to the cementitious composition and serves as a pozzolan/cementitious material and microfiller. Fly ash is an industrial byproduct, for example, collected from effluent of a coal burning boiler unit. It can be used as a substitute for a portion of the Portland cement binder to reduce energy consumption required to form the overall product and increase the environmental friendliness of the cementitious composition, while contributing to the cementitious properties of the matrix/binder system of the concrete composite. In certain variations, the fly ash may be a Class F fly ash or Class C fly ash as designated by ASTM C618 and C619, which may be formed from combustion of coals. ASTM C618 requires that Class F and Class C fly ashes contain at least 50% pozzolanic compounds (silica oxide, alumina oxide, and iron oxide). Class F fly ash may be formed from combustion of anthracite and/or bituminous coals, while Class C fly ash may typically be formed from combustion of lignite or subbituminous coal. Class F fly ash has less than about 18% maximum of calcium oxide (CaO), while Class C has greater than or equal to 18% calcium oxide (CaO). Class F fly ash has pozzolanic properties. Class C fly ash has pozzolanic properties, as well as some cementitious properties. The fly ash may be present in the cementitious composition at greater than or equal to 0 mass % to less than or equal to about 40 mass % of the total mass of cementitious composition and optionally at 0 greater than or equal to about 14 mass % to less than or equal to about 30 mass % of the total mass of cementitious composition. The fly ash may have an average particle size of about 30 micrometers in certain variations.

In yet other aspects, the cementitious composition includes a cellulose-based additive, such as hydroxypropylmethyl cellulose (HPMC). Generally, the HPMC manipulates viscosity of the cementitious compositions in its the fresh state, for example, it can be used as thickening agent to increase viscosity, prevent segregation during pumping, and promote thixotropy. The cellulose-based additive may be present in the cementitious composition at greater than or equal to 0 mass % to less than or equal to about 0.2 mass % of the total mass of cementitious composition, optionally at greater than or equal to about 0.05 mass % to less than or equal to about 0.1 mass % of the total mass of cementitious composition.

In other variations, microsilica, also called silica fume/fumed silica, may be added to the cementitious composition and generally has a particle size of greater than or equal to about 5 nm to less than or equal to about 200 nm. The microsilica or silica fume may be present in the cementitious composition at 0 mass % to less than or equal to about 5 mass % of the total mass of engineered cementitious composite, optionally at 0 mass % to less than or equal to about 1 mass % of the total mass of engineered cementitious composite, optionally at 0 mass % to less than or equal to about 0.5 mass % of the total mass of engineered cementitious composite, optionally at 0 mass % to less than or equal to about 0.1 mass % of the total mass of engineered cementitious composite, optionally at 0 mass % to less than or equal to about 0.025 mass % of the total mass of engineered cementitious composite. In one variation, the microsilica is present at about 0.033 mass % of the total mass of cementitious composite.

In certain variations, the engineered cementitious composite comprises, or alternatively consists essentially of or consists of, Portland cement binder at greater than or equal to about 20% by mass to less than or equal to about 26% by mass of the engineered cementitious composite, a tire-derived rubber granular component at greater than or equal to about 1.8% by mass to less than or equal to about 23% by mass of the engineered cementitious composite, a calcined clay component comprising a calcined clay, Portland cement component, and limestone at greater than or equal to about 9% by mass to less than or equal to about 15% by mass of the engineered cementitious composite, water at greater than or equal to about 19% by mass to less than or equal to about 31% by mass, superplasticizer at greater than or equal to about 0.26% to less than or equal to about 0.33% by mass of the engineered cementitious composite, and a polymeric or natural fiber at greater than or equal to about 1% by volume to less than or equal to about 2% by volume.

The rubber-modified engineered cementitious composite can be loaded in both tension and compression and embodies a built-in capability of crack width control without the need for steel reinforcement. Such an engineered cementitious composite may have a variety of advantageous properties, such as having a good ductility or tensile strain capacity of greater than or equal to about 3% and an ultimate tensile strength of greater than or equal to about 2.2 MPa. In certain variations, a tensile strain capacity may range from greater than or equal to about 3% up to about 8%, for example, optionally greater than or equal to about 4%, greater than or equal to about 5%, greater than or equal to about 6%, greater than or equal to about 7%, and in certain variations, optionally greater than or equal to about 3%. In certain variations, an ultimate tensile strength of the ECC material may have an ultimate tensile strength of greater than or equal to about 2.2 MPa up to about 3.8 MPa, for example, optionally greater than or equal to about 2.3 MPa, optionally greater than or equal to about 2.4 MPa, optionally greater than or equal to about 2.5 MPa, optionally greater than or equal to about 2.6 MPa, optionally greater than or equal to about 2.7 MPa, optionally greater than or equal to about 2.8 MPa, optionally greater than or equal to about 2.9 MPa, optionally greater than or equal to about 3 MPa, optionally greater than or equal to about 3.0 MPa, optionally greater than or equal to about 3.2 MPa, optionally greater than or equal to about 3.3 MPa, optionally greater than or equal to about 3.4 MPa, optionally greater than or equal to about 3.5 MPa, optionally greater than or equal to about 3.6 MPa, optionally greater than or equal to about 3.7 MPa, and in some variations, optionally greater than or equal to about 3.8 MPa.

The engineered cementitious composite may have a compressive strength of greater than or equal to about 20 MPa to less than or equal to about 40 MPa, for example, optionally greater than or equal to about 25 MPa, optionally greater than or equal to about 30 MPa, optionally greater than or equal to about 35 MPa, and in some variations, optionally greater than or equal to about 40 MPa.

In certain variations, the engineered cementitious composite prepared in accordance with the present teachings may have an average maximum crack opening width of less than or equal to about 50 micrometers, optionally less than or equal to about 40 micrometers, optionally less than or equal to about 30 micrometers, and in certain variations, optionally less than or equal to about 25 micrometers. As noted above, the inclusion of the tire-derived rubber component reduces an ECC's crack width, for example, decreasing from about 169 μm to about 37 μm in one ECC material as crumb rubber content increases (from 0 to 100% substitution of fly ash mass). Furthermore, incorporating the tire-derived granular rubber component promotes multiple fine cracking in the ECC material, in one example, increasing an average number of cracks from 16 up to 53.

The engineered cementitious composite materials may have strain hardening (PSH) behavior (PSH_{strength}=crack bridging capacity/first-cracking strength) of greater than or equal to 1 thus leading to high tensile strain capacity, by way of example, ranging from 11.5% to 13.3%.

In certain aspects, a concrete structure (e.g., cementitious composite) is formed from such an extremely durable concrete/engineered cementitious composition, where the structure is substantially free of any metal reinforcement (e.g., steel or iron-containing rebar) components.

In certain further variations, the engineered cementitious composite may further comprise, or alternatively consist essentially of or consist of, an additive selected from the group consisting of: silica sand present at greater than 0% by mass to less than or equal to about 17% by mass of the engineered cementitious composite, fly ash present at greater than 0% by mass to less than or equal to about 40% by mass of the engineered cementitious composite, microsilica or silica fume present at 0% by mass to less than or equal to about 5% by mass of the engineered cementitious composite, a cellulose-based viscosity modifier present at greater than 0.05% to less than or equal to about 0.1% by mass of binders present in the engineered cementitious composite. The binders comprise the Portland cement, the calcined clay component, and any fly ash, and combinations thereof.

In yet other variations, the present disclosure contemplates an engineered cementitious composite comprising, or alternatively consisting essentially of or consisting of, Portland cement binder at greater than or equal to about 21% by mass to less than or equal to about 24% by mass of the engineered cementitious composite, a tire-derived rubber granular component at greater than or equal to about 5% by mass to less than or equal to about 15% by mass of the engineered cementitious composite, a calcined clay component comprising a calcined clay, Portland cement component, and limestone at greater than or equal to about 10% by mass to less than or equal to about 12% by mass of the engineered cementitious composite, water at greater than or equal to about 27% by mass to less than or equal to about 31% by mass, a superplasticizer at greater than or equal to about 0.26% to less than or equal to about 0.33% by mass of the engineered cementitious composite, a polymeric or natural fiber at greater than or equal to about 1% by volume to less than or equal to about 2% by volume, silica sand present at greater than 0% by mass to less than or equal to about 17% by mass of the engineered cementitious composite, fly ash present at greater than 14% by mass to less than or equal to about 30% by mass of the engineered cementitious composite, a cellulose-based viscosity modifier present at greater than 0.05% to less than or equal to about 0.1% by mass of binders present in the engineered cementitious composite, wherein the binders comprise the Portland cement, the calcined clay component, and the fly ash. Such an engineered cementitious composite may have a tensile strain capacity of greater than or equal to about 7% and an ultimate tensile strength of greater than or equal to about 3.5 MPa.

The inventive technology providing such engineered cementitious composites thus can address a dual challenge of infrastructure renewal and waste tire disposal. The market of durable concrete is enormous and growing steadily. Hence, turning waste tires into a feedstock for extremely durable concrete creates a new opportunity to advance sustainable developments of both the concrete and automotive industries. The invented material is anticipated to reduce the operations and maintenance-related expense and emissions by promoting the durability and resiliency of civil infrastructure systems. The material can also be synergized with emerging sustainable construction approaches, such as additive manufacturing/three-dimensional (3D) printing.

In various aspects, the cementitious compositions providing a rubber-modified EDC can be applied to general civil infrastructure, including both precast and cast in-place construction. It can also be used as a durable repair material. The tight crack width is particularly desirable for water infrastructure and is conducive to the structural durability and resiliency by amplifying the self-healing capability. The cementitious compositions of the present disclosure have a broad range of strength grades and can be applied to a variety of structural and non-structural members, as well as infrastructure subjected to severe environments and extreme loadings.

Table 1 below shows exemplary ranges of various components in engineered cementitious composite compositions contemplated by the present disclosure given on a mass basis of the total composition unless otherwise indicated. Fiber content is also measured by volume of total composite material.

TABLE 1

| | Minimum mass/ | Maximum mass/ |
|---|---|---|
| | weight %, unless | weight %, unless |
| | otherwise indicated | otherwise indicated |
| Portland cement/clinker | 20 | 26 |
| (e.g., Type I) | | |
| Calcined Clay Component | 9 | 15 |
| (Limestone Calcined Clay | | |
| Cement (LC3)) | | |
| Tire-Derived Crumb Rubber | 1.8 | 23 |
| HRWRA/superplasticizer | 0.26 | 0.33 |
| (e.g., BASF (MasterGlenium | | |
| 7920 ™)) | | |
| Water | 19 | 31 |
| Polymer Fiber | 1 | 3 |
| (e.g., polypropylene fiber) | | |
| Vol. % | | |
| Silica sand | 0 | 17 |
| (e.g., F-75 silica sand) | | |
| Fly Ash | 0 | 40 |
| (e.g., Class F) | | |
| Viscosity Modifier/Cellulose- | 0 | 0.2 |
| Based Additive | | |
| (e.g., HPMC) | | |

Table 2 below shows ranges of components particularly suitable for engineered cementitious composite compositions contemplated by the present disclosure.

TABLE 2

| | Minimum mass/ | Maximum mass/ |
|---|---|---|
| | weight %, unless | weight %, unless |
| | otherwise indicated | otherwise indicated |
| Portland cement/clinker | 21 | 24 |
| (e.g., Type I) | | |
| Calcined Clay Component | 10 | 12 |
| (Limestone Calcined Clay | | |
| Cement (LC3)) | | |
| Tire-Derived Crumb Rubber | 5 | 15 |
| HRWRA/superplasticizer | 0.28 | 0.31 |
| (e.g., BASF (MasterGlenium | | |
| 7920 ™)) | | |
| Water | 27 | 31 |
| Polymer Fiber | 1.75 | 2.25 |
| (e.g., polypropylene fiber) | | |
| Vol. % | | |
| Silica sand | 0 | 17 |
| (e.g., F-75 silica sand) | | |
| Fly Ash | 14 | 30 |
| (e.g., Class F) | | |
| Viscosity Modifier/Cellulose- | 0.05 | 0.1 |
| Based Additive | | |
| (e.g., HPMC) | | |

Table 3 below shows specific examples of particularly suitable engineered cementitious composite compositions contemplated by the present disclosure.

TABLE 3

| Mass ratio, unless | | | | | | |
|---|---|---|---|---|---|---|
| otherwise indicated | Ex. 1 | Ex. 2 | Ex. 3 | Ex. 4 | Ex. 5 | Ex. 6 |
| Portland cement/clinker | 1 | 1 | 1 | 1 | 1 | 1 |
| (e.g., Type I) | | | | | | |
| Calcined Clay | 1 | 1 | 1 | 1 | 1 | 1 |
| Component (Limestone | (0.5:0.5) | (0.5:0.5) | (0.5:0.5) | (0.5:0.5) | (0.5:0.5) | (0.5:0.5) |
| Calcined Clay Cement | | | | | | |
| (LC3)) | | | | | | |
| (metakaolin:limestone) | | | | | | |
| Tire-Derived Crumb | 0.41 | 10% | 30% | 50% | 70% | 100% |
| Rubber^{a} | | | | | | |
| HRWRA/superplasticizer | 0.046 | 0.013 | 0.013 | 0.013 | 0.013 | 0.013 |
| (e.g., BASF | | | | | | |
| (MasterGlenium 7920 ™)) | | | | | | |
| Water | 0.88 | 1 | 1 | 1 | 1 | 1 |
| Polymer Fiber | 2* | 2 | 2 | 2 | 2 | 2 |
| (e.g., polypropylene fiber) | | | | | | |
| Vol. % | | | | | | |
| Silica sand | 0.4 | — | — | — | — | — |
| (e.g., F-75 silica sand) | | | | | | |
| Fly Ash | 1.8 | 1.8 | 1.4 | 1 | 0.6 | 0 |
| (e.g., Class F) | | | | | | |
| Silica Fume^{b} | — | — | — | — | — | — |
| | Ex. 7 | Ex. 8 | Ex. 9 | Ex. 10 | Ex. 11 | Ex. 12 |
| Portland cement/clinker | 0.95 | 0.9 | 0.85 | 0.8 | 0.8 | 0.8 |
| (e.g., Type I) | | | | | | |
| Calcined Clay | 1 | 1 | 1 | 1 | 1 | 1 |
| Component (Limestone | (0.5:0.5) | (0.5:0.5) | (0.5:0.5) | (0.5:0.5) | (0.5:0.5) | (0.5:0.5) |
| Calcined Clay Cement | | | | | | |
| (LC3)) | | | | | | |
| (metakaolin:limestone) | | | | | | |
| Tire-Derived Crumb | 50% | 50% | 50% | 50% | 50% | 50% |
| Rubber^{a} | | | | | | |
| HRWRA/superplasticizer | 0.013 | 0.013 | 0.013 | 0.013 | 0.018 | 0.031 |
| (e.g., BASF | | | | | | |
| (MasterGlenium 7920 ™)) | | | | | | |
| Water | 1 | 1 | 1 | 1 | 0.8 | 0.6 |
| Polymer Fiber | 2 | 2 | 2 | 2 | 2 | 2 |
| (e.g., polypropylene fiber) | | | | | | |
| Vol. % | | | | | | |
| Silica sand | 0.4 | — | — | — | — | — |
| (e.g., F-75 silica sand) | | | | | | |
| Fly Ash | 1 | 1 | 1 | 1 | 1 | 1 |
| (e.g., Class F) | | | | | | |
| Silica Fume^{b} | 5% | 10% | 15% | 20% | 20% | 20% |

^{a}substitution ratio of fly ash with crumb rubber by volume unless otherwise indicated.
^{b}substitution ratio of cement with silica fume by mass.
*2.0 vol. % is about 0.06 mass ratio in the material.

In various aspects, the present disclosure provides engineered cementitious composite materials that have the following advantages. First, the composites provide high-efficiency utilization of waste rubber tires as a value-added feedstock in the large-volume material construction industry. Further, extremely durable concrete materials are scalable with no market limits that further reduces significant carbon emissions both at the manufacturing phase and during operations and maintenance during the material's lifetime. For example, the engineered cementitious composites are damage tolerant and self-healing with no need for maintenance and repair. Additionally, the materials provided by the present disclosure enhance infrastructure safety, durability, and resiliency. These materials further synergize the sustainable development of the concrete and auto industries.

Various embodiments of the inventive technology can be further understood by the specific examples contained herein. Specific Examples are provided for illustrative purposes of how to make and use the compositions, devices, and methods according to the present teachings and, unless explicitly stated otherwise, are not intended to be a representation that given embodiments of this invention have, or have not, been made or tested.

### Examples

### Example 1

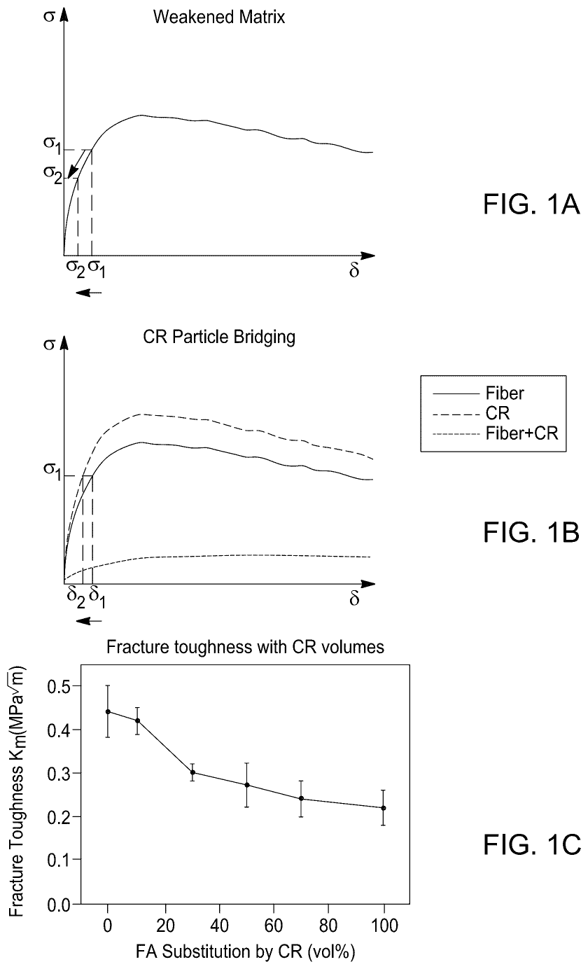

Tire-derived recycled crumb rubber (CR) was found to be an artificial flaw that improves the flaw distribution of ECC and enhances multiple cracking. As shown in FIGS. 1A-1B, both weakened matrix and CR particle bridging contribute to the crack width reduction of CR-ECC despite the weakened interface bonding of fiber/matrix caused by CR tending to enlarge the fiber slippage and crack opening. Specifically, the introduction of CR into the cementitious composition can reduce the matrix toughness due to the weak bond between CR and the cementitious matrix, resulting in lower cracking stress and crack opening in terms of the stress-crack opening (σ−δ) relation (FIG. 1A). In addition, some rubber particles can be interlocked and stretched between crack faces, hence providing a bridging force to restrain the crack opening combined with fiber bridging (FIG. 1B). As shown in FIG. 1C, inclusion of crumb rubber as a substitute for fly ash is shown to decrease a matrix fracture toughness (Kₘ) in the engineered cementitious composite as reflected in FIG. 1C. For example, an initial matrix fracture toughness is about 0.45 MPa \sqrt{m}, whereas a little over 20% substitution of fly ash results in a matrix fracture toughness of less than about 0.3 MPa \sqrt{m} and 100% substitution results in about 0.2 MPa \sqrt{m}.

### Example 2

This example explores mechanisms of tire-derived crumb rubber (CR) on crack width control of ECC, especially for the role of CR in the crack propagation of ECC. Specifically, this example investigates the effect of rubber particle bridging on the crack width control of ECC. More specifically, the tensile performance and crack pattern of CR-ECC were investigated experimentally. SEM and micro-CT scanning were applied to explore how CR affects the initiation and propagation of microcracks in the matrix qualitatively. The behavior of rubber particle bridging was characterized by the in-situ synchrotron micro-CT analysis under uniaxial tension. Based on the experimental results, the constitutive model of rubber particle bridging was developed, and the parameter analysis was conducted to quantitatively evaluate the crack width reduction. This provides a deeper understanding of the effect of rubber on the crack width control of ECC and guidance on the design and function-tailoring of ECC materials. The tight crack width of ECC can ensure the durability of structures and enhance the life cycle sustainability of infrastructure.

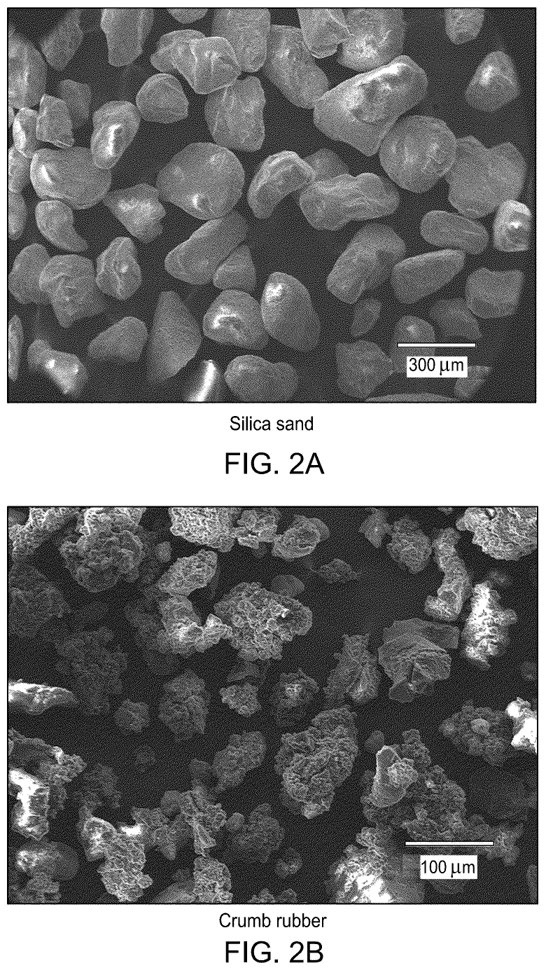

The mixture proportion of engineered cementitious composite (ECC) compositions includes the binder materials, aggregate, and high-strength polyethylene (PE) fiber, as shown in Table 4. The calcined clay component/LC3 binder includes the following components: ordinary Portland cement (Type I, Argos Co. (denoted OPC)), metakaolin (denoted MK, Imerys Co.), and limestone (denoted LM, Imerys Co.). Boral Co. provided fly ash (denoted FA), and F-75 fine silica sand (denoted “Sand,” was commercially available from U.S. Silica Co.) was used as the aggregate in the mixture. Entech Co. provided crumb rubber (CR) with an average particle size of 125 μm and a bulk density of 900 kg/m³. SEM images of sand and crumb rubber are shown in FIGS. 2A-2B, respectively. The water/binder ratio (w/b) was 0.2, and the superplasticizer (SP) from BASF (MasterGlenium 7920™) was used for water reduction and to maintain a proper mix flowability. PE fiber has a tensile strength of 2900 MPa and a density of 970 kg/m³. The fiber content of 2 vol. % with a diameter of 24 μm and length of 18 mm was used for all mixes. Compared to the control mixture (Control), tire-derived CR was used in the mixture (Example) to replace 75% of silica sand by volume.

TABLE 4
Mixture proportion (by weight) of ECC

| Mixture | OPC | MK | LM | FA | Sand | CR | Water | SP | Fiber |
|---|---|---|---|---|---|---|---|---|---|
| CONTROL | 1 | 0.5 | 0.5 | 2.4 | 1.58 | — | 0.88 | 0.046 | 0.060 |
| EXAMPLE | 1 | 0.5 | 0.5 | 1.8 | 0.40 | 0.41 | 0.88 | 0.046 | 0.060 |

### Mechanical Performance Tests

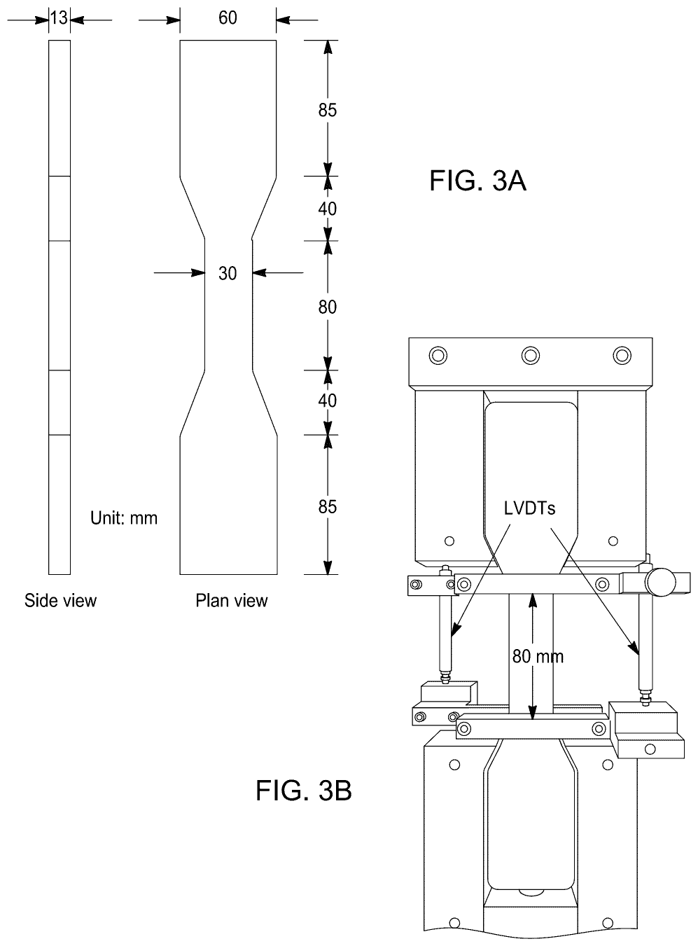

Dogbone specimens were prepared to determine the tensile performance of ECC, including the mechanical properties and crack pattern. Four specimens of each mixture were cast and tested after 28 days in the air curing condition. The dogbone-shaped molds have the geometry suggested by the Japan Society of Civil Engineers (JSCE) FIG. 3A to ensure that most cracks occur in the central area. The uniaxial tensile test set-up is shown in FIG. 3B, and the test was conducted with the displacement control rate of 0.5 mm/min. With two external linear variable displacement transducers (LVDTs) attached to the central part of the specimen, the deformation and the crack number were recorded, and the average crack width at one percent strain increment was calculated accordingly.

The fracture toughness of the ECC matrix was obtained by the three-point bending test following ASTM E399. The beam specimen with 38 mm×76 mm×305 mm was notched at the bottom middle with an initial crack length of 30 mm before the test. The bending test was conducted under the displacement control rate of 0.02 mm/min with a span/depth ratio equal to 3.3. The elastic modulus of the matrix is obtained by the uniaxial tensile test of matrix specimens.

A single fiber test was conducted to determine the interfacial bonding of fiber and matrix for the micromechanical modeling as described below.

### Micro Observation and In-Situ Micro-CT Scanning Analysis

To understand the role crumb rubber played in crack width control, scanning electron microscopy (SEM) and synchrotron X-ray Computed Microtomography (micro-CT) were used to characterize the microstructure. The uniaxial tensile test of the EXAMPLE ceased at 2% tensile strain and unloaded. Afterward, the middle spans of the samples were cut and observed via SEM and micro-CT scanning.

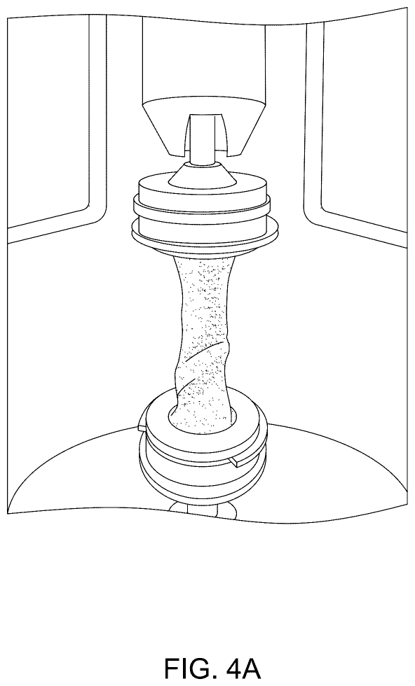

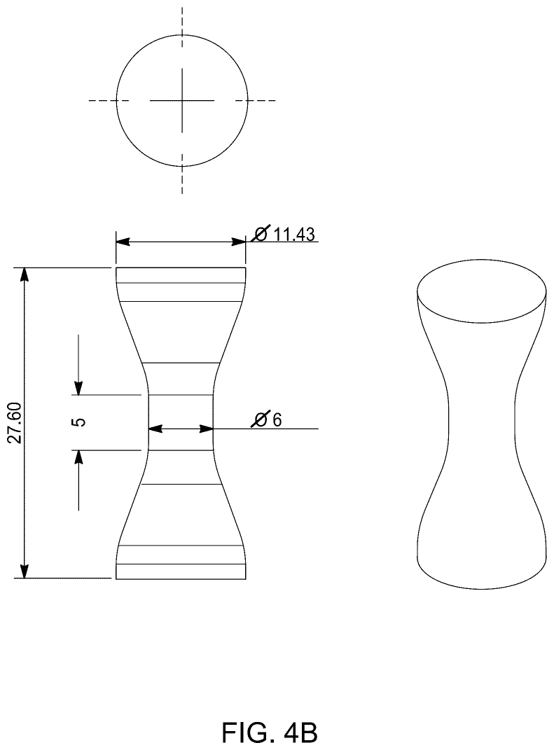

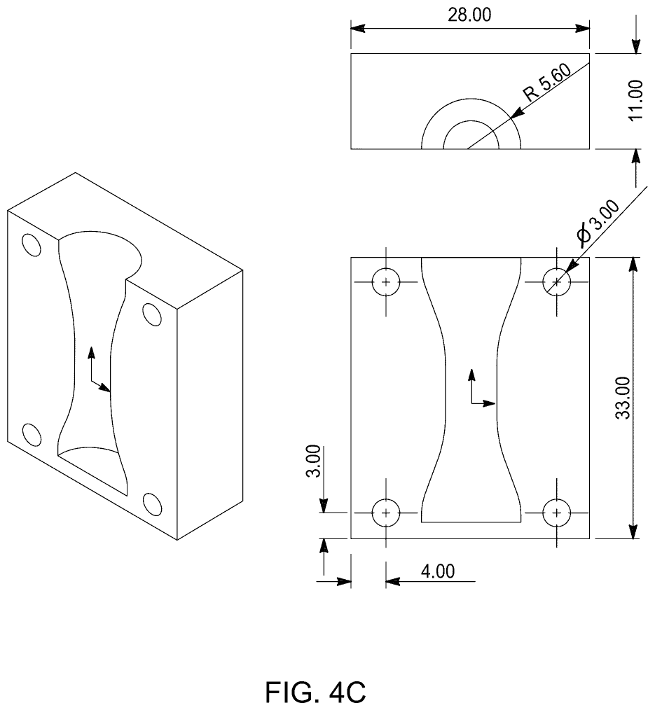

In addition, the EXAMPLE was also cast for in-situ synchrotron micro-CT analysis. The in-situ experiments enable specimens to be tested under direct tension while the specimen's region of interest is scanned by micro-CT simultaneously. The ECC specimen was cast in a specially designed three dimensionally printed (3DP) mold to satisfy the dimensional requirements of both the CT scan and testing device, as shown in FIGS. 4A-4C. After demolding and curing for 28 days, the two ends of the specimen were encased within stainless steel loading heads as shown in FIG. 4A. The brass spheres were attached to the loading heads ensuring the specimen was compatible with the testing apparatus' ball and socket connection.

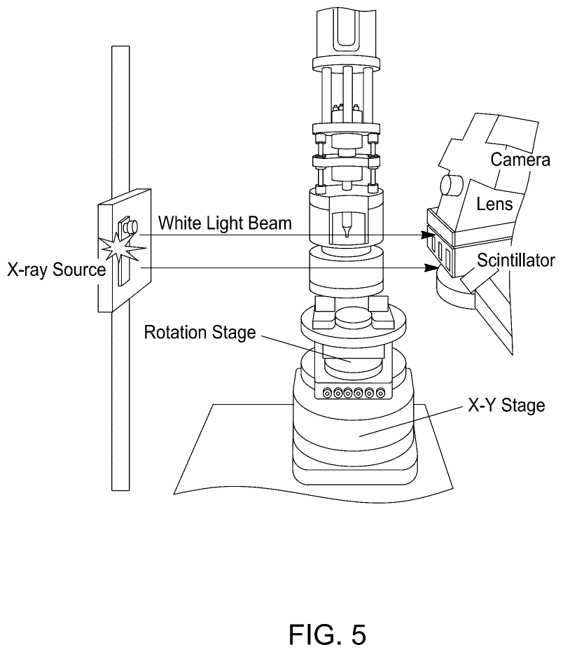

The in-situ micro-CT and uniaxial tensile test set-up are shown in FIG. 5. The experiment was conducted at Beamline 8.3.2 at the Advanced Light Source (ALS) of the Lawrence Berkeley National Laboratory. A white beam was used in the experiment, where the X-ray beam needs to go through the ECC samples. The beam energy was set to 35 keV, which is adequate for the penetration of the specimens; the intensity is kept constant at 500 mA. During a scan, the sample was mounted on the circular holder and was rotated about an axis perpendicular to the horizontal plane over 180°, with a total of 1969 2D radiographs in a 3D tomogram. Each projection was acquired on a 2560px CCD camera (PCO.edge sCMOS) equipped with a 4 mm field of view (FOV) along the height and a 2× Mitutoyo magnification optical objective lens. The pixel resolution under these conditions was 3.2 μm, and the plane's FOV was around 8.2 mm. Reconstructed slices (tomograms) were computed using the filtered back projection algorithm on Tomopy at the ALS. After reconstruction, the 3D tomograms were processed to increase the phase contrast and remove noise based on previous works.

### Tensile Performance

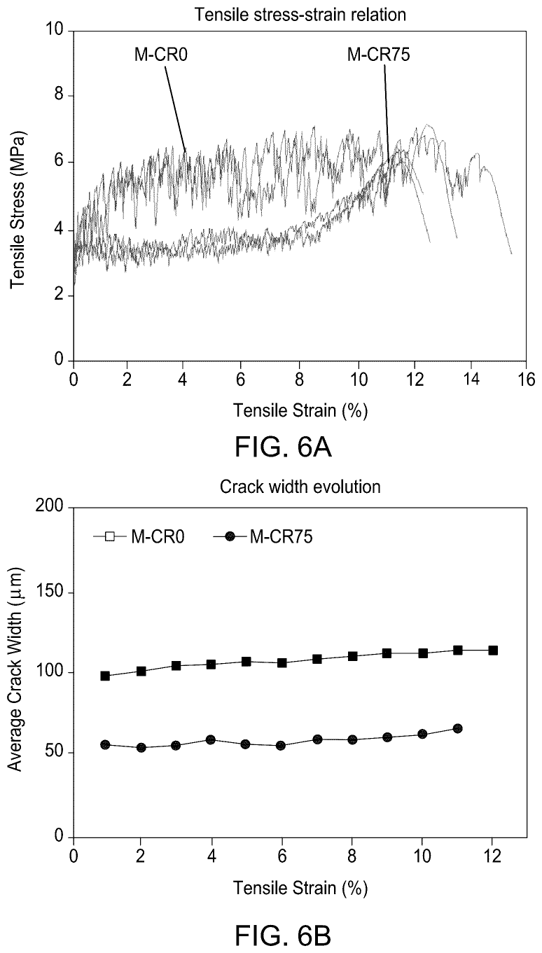

The tensile stress-strain curves and crack width evolution of these two mixtures are shown in FIGS. 6A-6B. Both mixtures exhibit significant strain-hardening characteristics, multiple cracking behavior, and high ductility. Like conventional PVA-ECC, three typical phases, including the elastic deformation stage, strain-hardening stage, and failure stage, can be observed from the tensile stress-strain curves of the studied ECCs. Typically, the strain-hardening stage is accompanied by multiple cracking, which is reflected by the stress drop as well as the fluctuation of the curve. Compared to the non-CR mixture (CONTROL-Labeled M-CRO), adding CR (EXAMPLE-labeled M-CR75) reduced the cracking stress and the stress fluctuation related to the crack opening, consistent with the crack width evolution, as shown in FIG. 6B.

The tensile properties in terms of first cracking strength σ_{fc}, ultimate tensile strength σᵤₜ, tensile strain capacity εᵤₜ, crack number N_{c}, average crack width at peak stress w_{c}, and average crack spacing Sc of the EXAMPLE versus CONTROL are summarized in Table 5. The average crack width and crack spacing were calculated based on the crack number within the 80 mm gauge length of the central part of the specimen. Compared to non-CR ECC (CONTROL-M-CRO), the first cracking strength of CR-ECC (EXAMPLE-M-CR75) is reduced from 3.74 MPa to 3.31 MPa due to the weakened matrix. The tensile strength also exhibits a decreasing trend, indicating a reduction in fiber bridging capacity which is determined by fiber strength, fiber content, and frictional bonding of PE fiber/matrix. Since CR is chemically inert in the cementitious matrix, the interface transition zone (ITZ) microstructure is affected by CR particles with the dilution of cement hydration products and increased porosity, resulting in reduced interfacial bonding of the fiber/matrix. The peak tensile stress of both mixtures was about 1.9 to 2 times higher than the first cracking strength, meeting the strength criterion of pseudo strain hardening (PSH) behavior, thus leading to high tensile strain capacity, ranging from 11.5% to 13.3%. The tensile strain capacity of ECC is associated with the crack width and the density of multiple cracking. The high tensile strain capacity of non-CR ECC is caused by fewer cracks but larger crack widths. On the contrary, more cracks and lower crack width lead to comparable tensile strain capacity of CR-ECC. The hydrophobicity of crumb rubber caused the weak bond between CR and matrix, which can be treated as artificial flaws. Improved flaw distribution triggers more microcracks during the strain-hardening stage, ensuring the saturated multiple cracking.

As shown in FIG. 6B, the average crack width gradually increases with tensile strain for both mixtures, and at the failure stage, the average crack width reaches its peak. Overall, the average crack width of the EXAMPLE (M-CR75) is around 52%-57% of that of CONTROL (M-CRO). As discussed herein, crumb rubber affects the crack width control of ECC in three aspects, matrix, fiber/matrix interface, and rubber particle bridging. The weak bond to the surrounding matrix of rubber due to its hydrophobicity reduces the energy to break material bonds at the crack tip, resulting in a lowered fracture energy and toughness of the matrix. The experimental results show that the EXAMPLE CR-matrix's fracture toughness and elastic modulus are 57% and 90% of that of the original (CONTROL) matrix, respectively. The strain-hardening stage of EXAMPLE (M-CR75) occurred at lower stress with smaller crack width. Another contributor to the crack width reduction, rubber particle bridging, is discussed in the following section.

TABLE 5
Tensile properties of ECC mixtures (average value)

| Mixture | σ_{fc} (MPa) | σᵤₜ (MPa) | εᵤₜ | N_{c} | w_{c} (μm) | S_{c} (mm) |
|---|---|---|---|---|---|---|
| CONTROL | 3.74 | 7.52 | 13.3% | 103 | 123.5 | 0.78 |
| EXAMPLE | 3.31 | 6.37 | 11.5% | 138 | 66.7 | 0.58 |

### Microstructural Analysis on the Pre-Tensioned Specimen

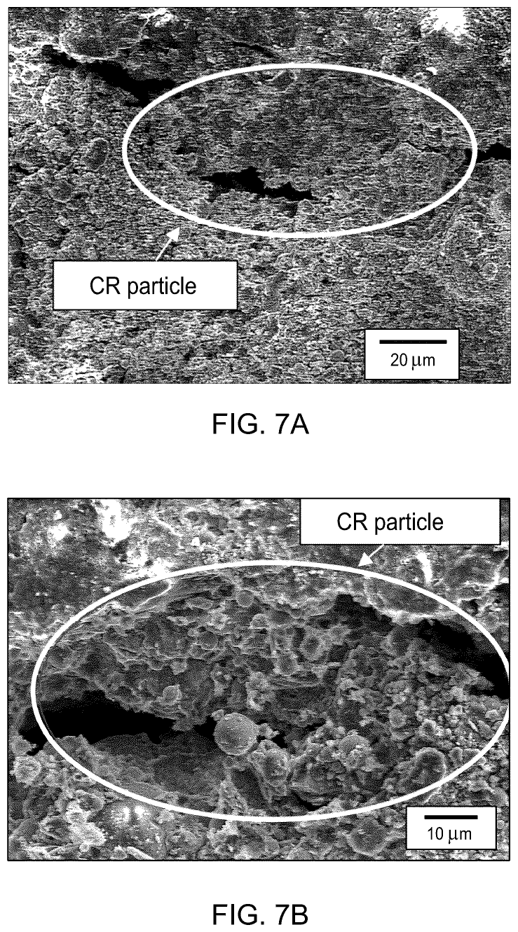

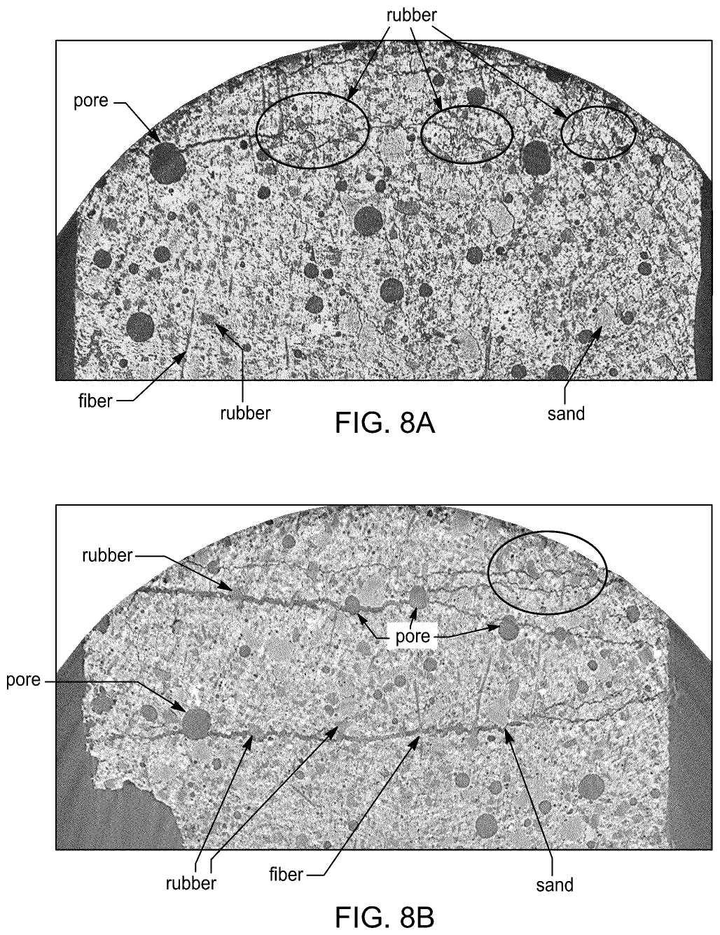

SEM and micro-CT scanning observed the microstructure of the pre-tensioned specimen to understand how CR influences the cracking behavior of ECC. As shown in FIGS. 7A-7B, some rubber particles were observed to link crack faces on the completely formed cracks. It is reasonable that CR particles can be interlocked in the matrix due to the irregular shape of CR particles. Micro-CT scanning provided further evidence, as shown in FIGS. 8A-8B, which presents 2D slices of reconstructed images for two different regions of interest (ROIs). The planes of 2D images are parallel to the tensile load direction and are at the middle depth of the samples. Each element in the specimen (rubber, pore, fiber, aggregate, and matrix) can be identified depending on the morphology and grayscale in micro-CT images. The fibers show a large aspect ratio, and the pores or air voids are black with a round shape. The sand particles are light gray with high roundness, while the crumb rubber particles are dark gray with irregular shapes. The black curves that cross the whole ROIs are identified as cracks. The cracks in both SEM and micro-CT 2D slice images are in unloaded condition, and the width is around 50% of that under loaded condition, which is consistent with that reported in the literature. Meanwhile, the slice images characterize the crack propagation affected by each element. The cracks across the voids, rubber, and sand indicate that micro-cracks were initiated at these deflects due to the weak bond with the cementitious matrix, as herein. Some rubber particles are interlocked in the matrix and can be stretched with the crack opening, which will be discussed in detail in the following section. Also, the rubber particles appear to alter the crack paths. Crack deflections were observed for all regions where crumb rubber particles intercept the crack planes. Besides, crack scatterings around the crumb rubber were observed as marked by circles. When a crack propagated through the crumb rubbers, the crack was split and deflected into several microcracks. The deflections and bifurcation of cracks contributed to the crack width control capacity and the ductility of ECC with crumb rubber.

### In-Situ Synchrontron Micro-CT Analysis Under Uniaxial Tension

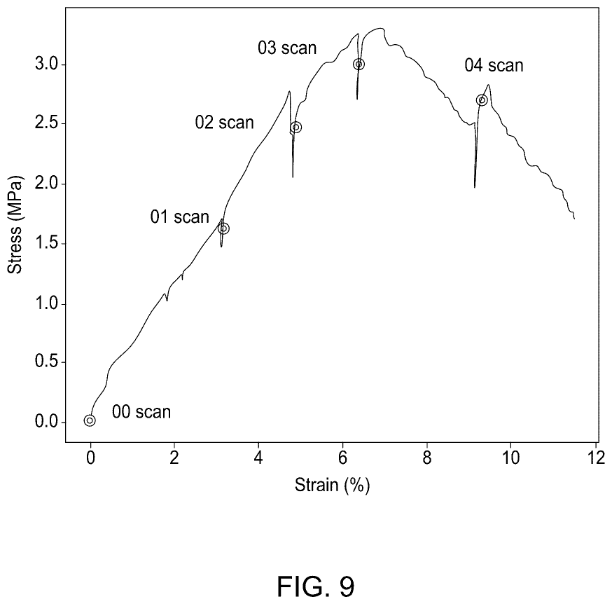

FIG. 9 shows the stress-strain relationship of the EXAMPLE mixture (M-CR75) in the in-situ tension test and the corresponding micro-CT scans at different test stages. A total of five scans were made, as marked in the tensile curve. The 00-scan was conducted at the initial state before the load was applied. The 01-scan was acquired at around 50% of ultimate strength. The 02-scan was acquired at around 75% of ultimate strength. The microcrack that occurred at this moment was observed and analyzed. The 03-scan was conducted when the stress reached the ultimate strength of the sample. Multiple cracks were observed during the tension test. Finally, the 04-scan was acquired just before the sample failure. It should be noted that the tensile performance of the specimen for the in-situ tension test is different from that of the uniaxial tension test of dogbone specimens, which might be attributed to the casting difficulty and the poor fiber dispersion due to the limited size of molds for micro-CT scanning. This effect can be ignored since the focus is on the role of rubber particles on crack width control in this micro-CT analysis.

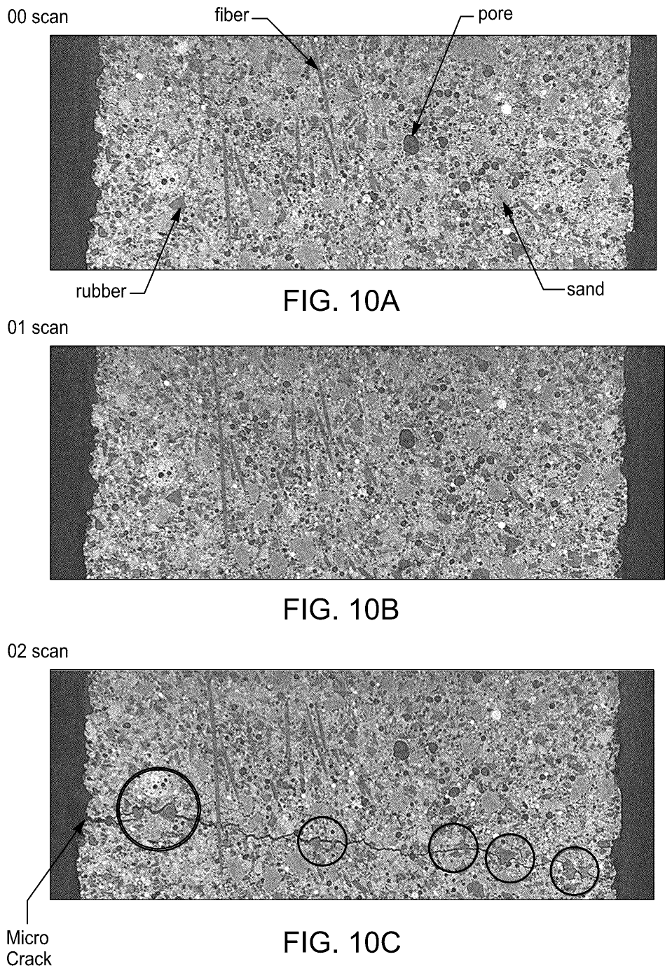

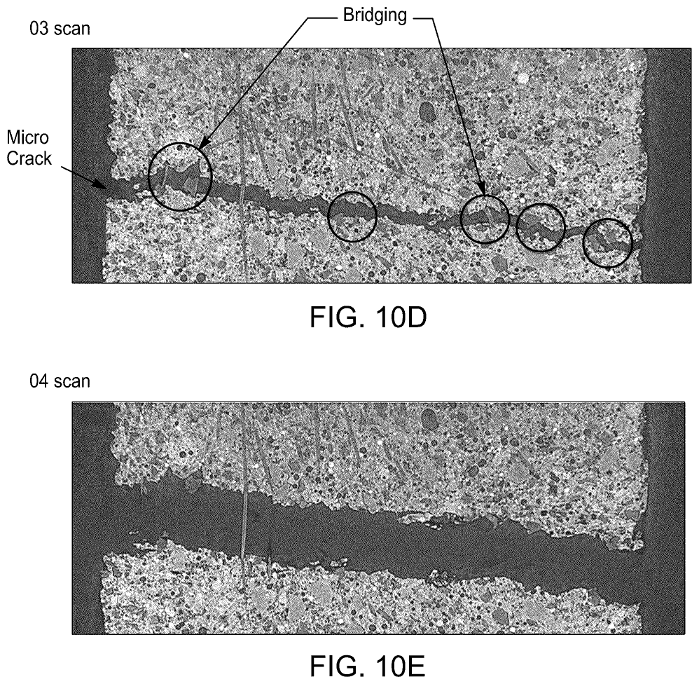

FIGS. 10A-10E show a time-series of observations of crack propagations in ECC with crumb rubber at a specific crack at a scale of the whole cross-section, as shown in FIG. 9. Before achieving cracking stress of the specific cross-section, the observed region, including cementitious matrix, fiber, and CR, deformed elastically, as shown in FIGS. 10A-10B. When reaching the cracking stress of a given cross-section, a microcrack was initiated at the flaw or defect locations in the fracture process zone. Unlike the tension softening behavior of the cementitious material, with the separation of the cementitious portion and debonding between the cementitious portion and aggregate particles, the tensile stress of ECC did not drop to zero. Instead, an increase in load after a small stress drop was observed due to the fiber bridging. Many load fluctuations occurred on the tensile stress-strain curve in response to the multiple cracking until the end of the tensile strain-hardening stage. In the 02-scan, the selected cross-section entered the cracking state, and a horizontal microcrack with a width of 10-30 μm occurred across the whole observed region (FIG. 10C). Crumb rubber particles can be seen between the crack plane as marked as circles. As crack opening further increased, the interlocked rubber particles were stretched, sustaining, and transferring load in cooperation with fibers, as shown in the 03-scan (FIG. 10D). The rubber particles were observed serving the bridging effect at the crack width of 80-180 μm in the 03-scan. With the further crack opening, the ruptured rubber particles were observed with fiber bridging remaining, as shown in the 04-scan.

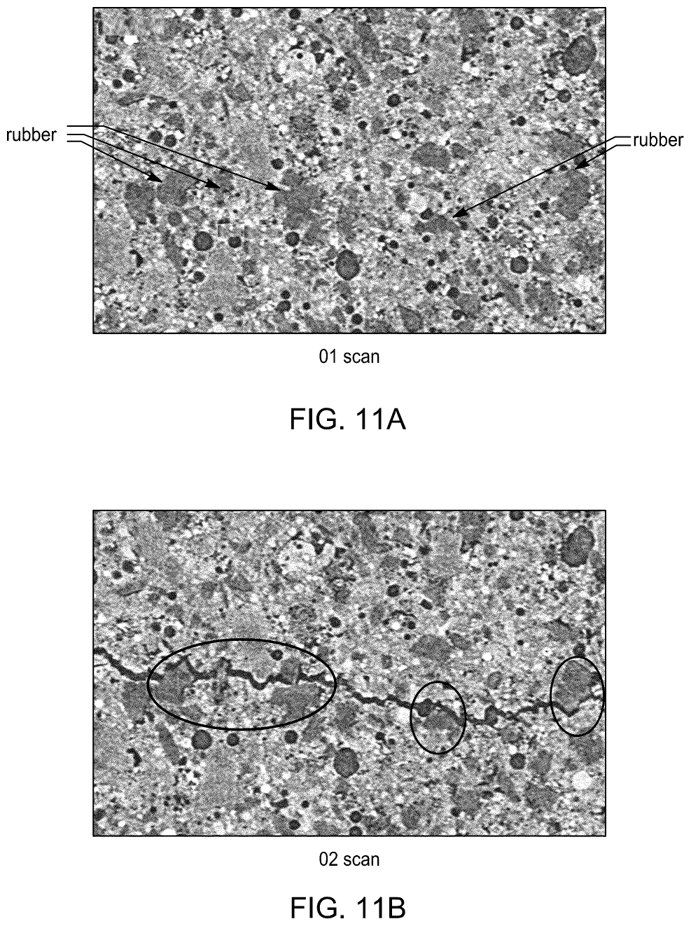

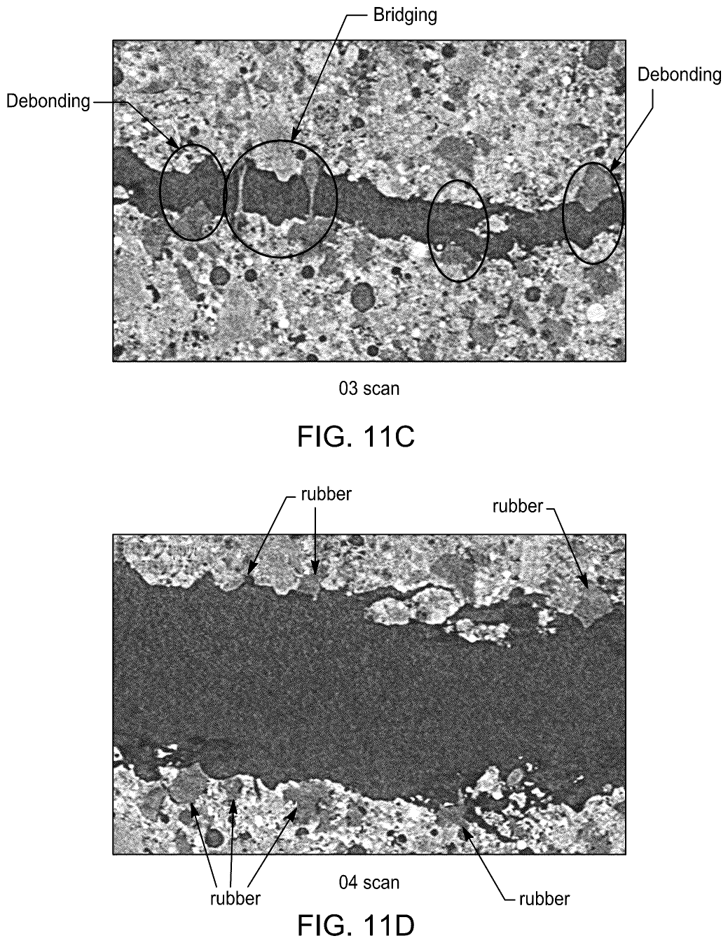

FIGS. 11A-11D provide more evidence of crumb rubber bridging in the local image analysis. Microcracks were initiated at the defects and propagated along the cross-section by breaking cementitious portions or the bond between aggregates (sand and CR in this example). However, when the straight crack front approached a well “bonded” rubber particle, the propagation was hindered or deflected. This bond is caused by the interlock physically since rubber is hydrophobic and weakly bonded to the surrounding matrix. Except for the interlock parts at both ends of the rubber, the middle part can be stretched to restrain the crack opening till the tensile strain capacity of the rubber is exhausted, as shown in FIGS. 11C and 11D.

The above observation on the micro-scale has fully shown qualitatively microcrack opening and crumb rubber response during the uniaxial tensile loading. The following additional investigation is to establish the rubber particle bridging model and quantitively evaluate its effect on crack width control of ECC.

### Modeling of CR Particle Bridging

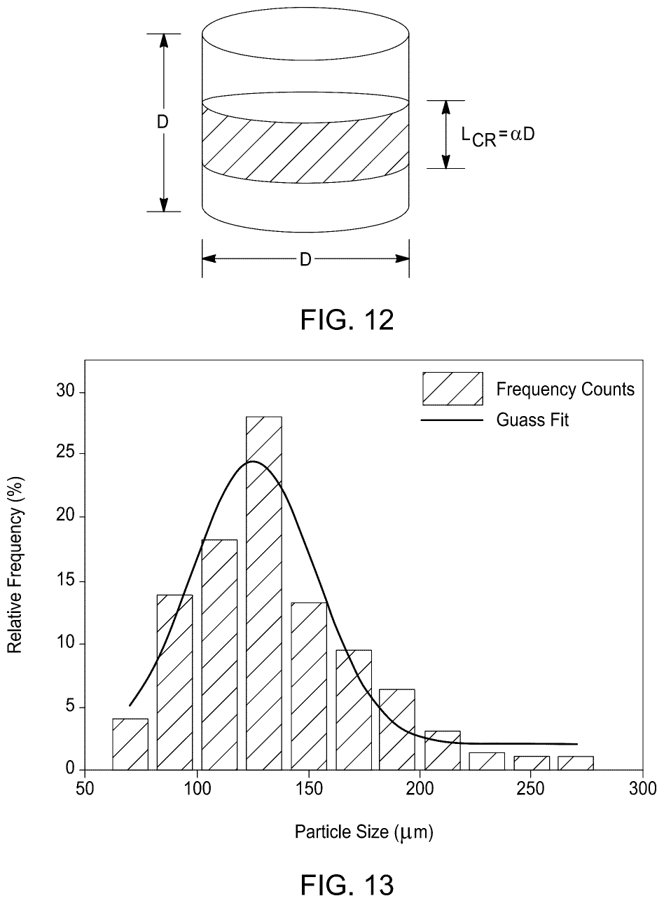

Due to the irregular shape of crumb rubber in SEM observation, the CR particles can be seen as cylinders when stretching with the crack opening. For simplicity, the diameter and height of the CR particle are the same value D, as shown in FIG. 12. If the rubber particle can sustain and transfer load between the crack faces, both ends of the particle should be interlocked in the matrix, as discussed previously. Thus, the debonded length L_{CR} undergoing stretch is less than the particle size, and it is reasonable to assume L_{CR}=αD, and α is less than 1. Since crumb rubber has a large elongation capacity, the crack opening δ value might be several times the stretching length L_{CR}.

Since the rubber cannot stretch beyond the ultimate tensile strain ε_{CR}^{c},

$${ε}_{CR} = \frac{δ}{{L}_{CR}} = \frac{δ}{α D} \leq {ε}_{CR}^{c} \qquad ( 1 )$$

Thus, at a given crack opening δ, the effective particle size that can serve bridging effect should follow:

$$D \geq \frac{δ}{α {ε}_{CR}^{c}} \qquad ( 2 )$$

Particles with D less than or equal to

$$\frac{δ}{a {ε}_{CR}^{c}}$$

would have ruptured. As the crack opening δ increases, more and more rubber particles fail, so the closing pressure exerted by the bridging particles would decrease. This means that at any given crack opening δ, the minimum particle size that remains bridging the crack is:

$${D}_{min} = \frac{δ}{α {ε}_{CR}^{c}} \qquad ( 3 )$$

where
D: CR particle size;
α: the debond length ratio;
L_{CR}: the debonded length;
δ: crack opening;
ε_{CR}: the tensile strain of CR;
ε_{CR}^{c}: the ultimate tensile strain of CR;
Dₘᵢₙ: the minimum particle size for CR particle bridging;

Based on the size distribution statistics by SEM observation, the size distribution of CR particles follows the normal distribution, as shown in FIG. 13. The normal distribution function is expressed as

$$f ( D ) = \frac{1}{φ \sqrt{2 π}} \cdot {e}^{- \frac{1}{2} {( \frac{D - μ}{φ} )}^{2}} \qquad ( 4 )$$

where μ is the mean size; φ is the standard deviation. These parameters can be obtained from the best curve fit.

Assuming that rubber is stretching linearly, then the load that CR particle can sustain is expressed as below:

$$σ = ε {E}_{C R} = \frac{δ}{α D} {E}_{C R} \qquad ( 5 )$$

The force carried by a CR particle of diameter D when the crack opening δ should be:

$$P ( D ) = σ \cdot \frac{π}{4} {D}^{2} = \frac{π {E}_{C R}}{4 α} δ D \qquad ( 6 )$$

According to the probability density function of size distribution, the average stress of CR particles can be expressed as a function of crack opening δ.

$${σ}_{C R} = \frac{{V}_{CR}}{{\overline{A}}_{CR}} \cdot {\int }_{{D}_{min}}^{{D}_{max}} f ( D ) \cdot P ( D ) dD = \frac{{V}_{CR}}{{\overline{A}}_{CR}} \cdot \frac{{\int }_{δ}^{+ ∞}}{a {ε}_{CR}^{c}} f ( D ) \cdot P ( D ) dD \qquad ( 7 )$$

where
V_{CR}: rubber volume fraction;
Ā_{CR}: the cross-section area with average particle size,

$${\overline{A}}_{CR} = \frac{π}{4} {D}_{50}^{2} ;$$

D₅₀: the average particle size;
Dₘₐₓ: the maximum particle size;
ƒ(D): the probability density function of size distribution;

Considering that not all particles are interlocked and participate in crack bridging, the effective CR volume fraction needs to be reduced by an effective participation ratio parameter β (0<3<1).

Therefore, by substituting Eq. (6) into Eq. (7), the stress of CR particle bridging is expressed as

$${σ}_{CR} ( δ ) = \frac{β {V}_{CR} {E}_{CR}}{α {D}_{50}^{2}} \frac{{\int }_{δ}^{+ ∞}}{a {ε}_{CR}^{c}} f ( D ) \cdot δ Dd D \qquad ( 8 )$$

### Prediction of Modeling and Experimental Verification

The major source of waste rubber is tire waste, in which the Styrene-Butadiene Rubber (SBR) is reinforced with carbon black, silica compounds, etc. The sources, reinforcement methods, and other additives lead to the variation of the physical and mechanical properties. The typical properties of carbon black reinforced SBR are shown in Table 6. Besides, the waste tire rubber went through a thermal history during use on the road in addition to a grinding process to become ground rubber powder, so the deterioration of mechanical properties should be considered. Due to the unavailability of the properties of waste tire from the provider, a knock-down factor g<1 is introduced for the initial tensile strain capacity ε_{CR}^{c}.

Therefore, the final CR bridging stress can be written as

$${σ}_{CR} ( δ ) = \frac{β {V}_{CR} {E}_{CR}}{α {D}_{50}^{2}} \frac{{\int }_{δ}^{+ ∞}}{a γ {ε}_{CR}^{c}} f ( D ) \cdot δ D d D \qquad ( 9 )$$

TABLE 6
Modeling parameters of crumb rubber

| | Tensile strain | Young's modulus |
|---|---|---|
| | capacity ε_{CR}^{c} | ε_{CR} (MPa) |
| Crumb rubber | 320% | 3.8 |

* Data from the CES database (Granta (CES) EduPack, Cambridge, UK, 2021, (n.d.)).

In order to calculate the stress of CR particle bridging in Eq. (9), the value of α, β and γ need to be pre-determined. The micro-CT scanning result shows that rubber particles are interlocked in the matrix with different sizes due to the irregular shape, and even deboned at one end without bridging contribution. Assuming α=0.5, i.e., the half of rubber is stretching with the crack opening, the stress of CR particle bridging can be calculated with the crack opening. For the effective particle bridging ratio between cracks, the ratio β is confirmed by the micro-CT scanning result, which shows that around 30% of particles are serving the bridging effect with the crack opening, so β is set as 0.3 initially. The discount of tensile strain capacity caused by deterioration is not considered in the initial modeling.

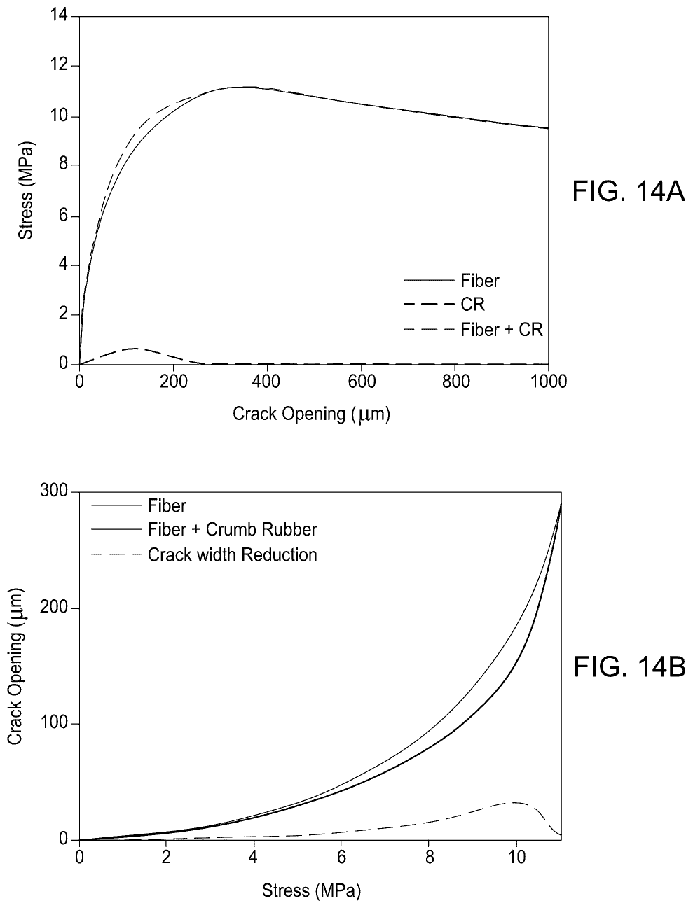

Using the fiber/matrix interfacial bonding and matrix properties of non-CR ECC, the fiber bridging relation (σ_{ƒ}−δ) is computed using the MATLAB program. Based on the principle of superposition, the complete stress-crack opening (σ−δ) relation for CR-ECC is shown in FIG. 14A. The stress is enhanced by CR particle bridging, and thus the crack width is reduced at the same cracking strength. The relationship between crack width and stress before the bridging capacity is shown in FIG. 14B. When at the cracking stress level of the strain-hardening stage (4-6 MPa in this example), the crack width is reduced by 6.7%-10.7% due to CR particle bridging.

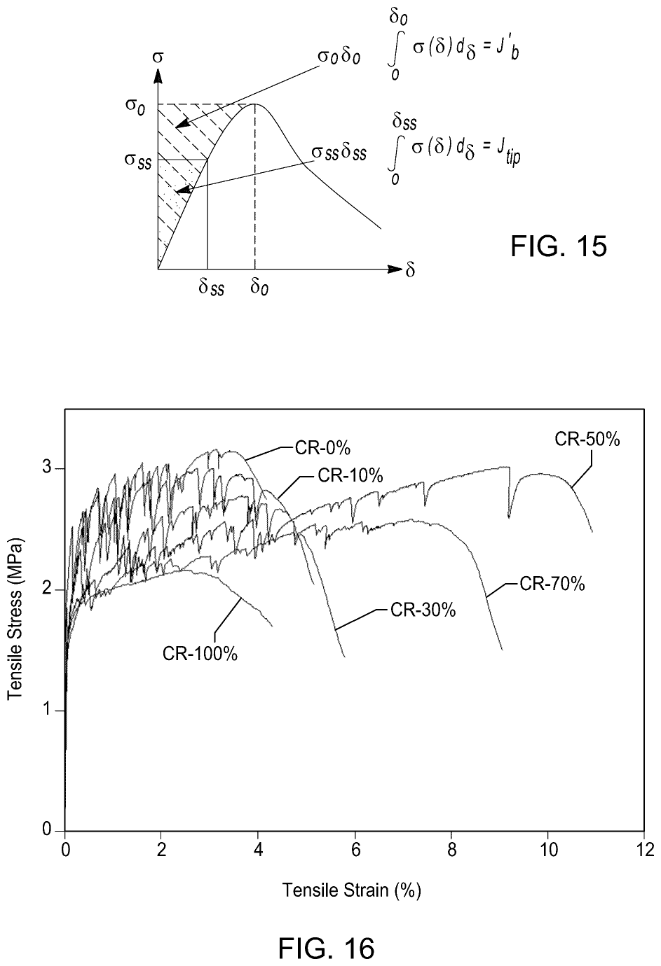

To compare the effects of both weakened matrix and CR particle bridging on the crack width, the crack width reduction caused by the weakened matrix is also estimated in the following discussion. To ensure steady state cracking, the complementary energy of fiber-bridging J′_{b} should exceed the crack tip toughness Jₜᵢₚ (FIG. 15). At small fiber content, Jₜᵢₚ can be represented as the energy consumed in the fracture process and therefore can be calculated by Kₘ²/Eₘ, where Eₘ is the matrix Young's modulus.

$${σ}_{ss} {δ}_{ss} - {\int }_{0}^{{δ}_{ss}} σ ( δ ) d δ = {J}_{tip} = \frac{{K}_{m}^{2}}{{E}_{m}} \qquad ( 1 )$$

Assuming the slope of σ−δ curve before cracking is linear, the shaped area can be calculated geometrically and

$${J}_{tip} = \frac{1}{2} {σ}_{ss} {δ}_{ss} ∝ {δ}_{ss}^{2} \qquad ( 2 )$$

thus,

$${δ}_{ss} ∝ \frac{{K}_{m}}{\sqrt{{E}_{m}}} \qquad ( 3 )$$

Therefore, the crack opening reduction due to a weakened matrix can be

$$1 - \frac{{K}_{m} / \sqrt{{E}_{m}}}{{K}_{mo} / \sqrt{{E}_{mo}}} ,$$

where the subscript “0” indicates the value without CR, and estimated as other parameters without the subscript “0” represent the value with CR.

Table 7 shows a comparison of experimental and predicted results of crack width of ECC. These parameters are in normalized form, i.e., the parameter with CR addition is divided by that without CR. As shown in Table 7, the experimental observation of crack width reduction is in the range of 42.8%-48.4% for all the tensile strains from FIG. 6B. The crack width reduction caused by the weakened matrix alone is around 40%, while the crack reduction caused by CR particle bridging is in the range of 6.7%-10.7% from FIG. 14B. Hence, combined with the effects of weakened fracture toughness, the predicted results correlate reasonably with the experimental results on the magnitude of crack width reduction.

TABLE 7
Comparison of experimental and predicted
crack width reduction by CR

| | |
|---|---|
| Experimental results | Predicted results |

| 1-CW/CW₀ | Due to matrix weakening | Due to bridging |
|---|---|---|
| 42.8-48.4% | 39.9% | 6.7-10.7% |

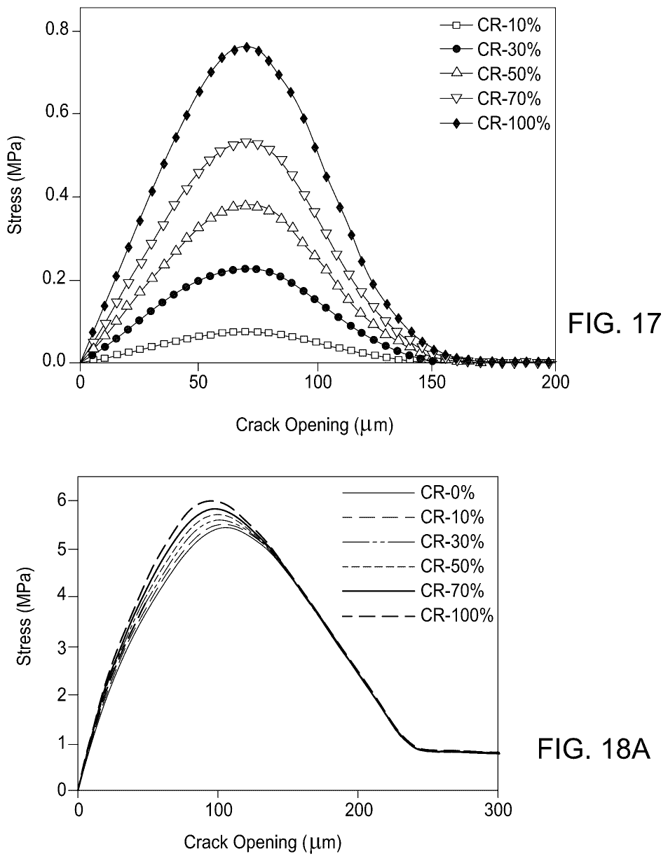

For further verification, an example case study is as follows. The prediction of crack width reduction with different CR content was also conducted and compared with data from the literature to verify the validity of this model. FIG. 16 shows the tensile stress-strain relations of CR substituting fly ash by volume of PP-ECC. The CR particle bridging stress with different content is computed with the above model as shown in FIG. 17. It implies that particle bridging stress increased with CR content and reached the maximum (0.76 MPa) at 100% CR content.

FIG. 18A shows a stress-crack opening (σ−δ) relation of CR-ECC with different rubber particle content. At the same crack opening, the stress is enhanced by rubber bridging. As shown in FIG. 18B, the crack width is reduced with rubber content. In the range of cracking stress (2-3 MPa from the experimental results in FIG. 16), the crack width was reduced by 2%-19% for different rubber content.

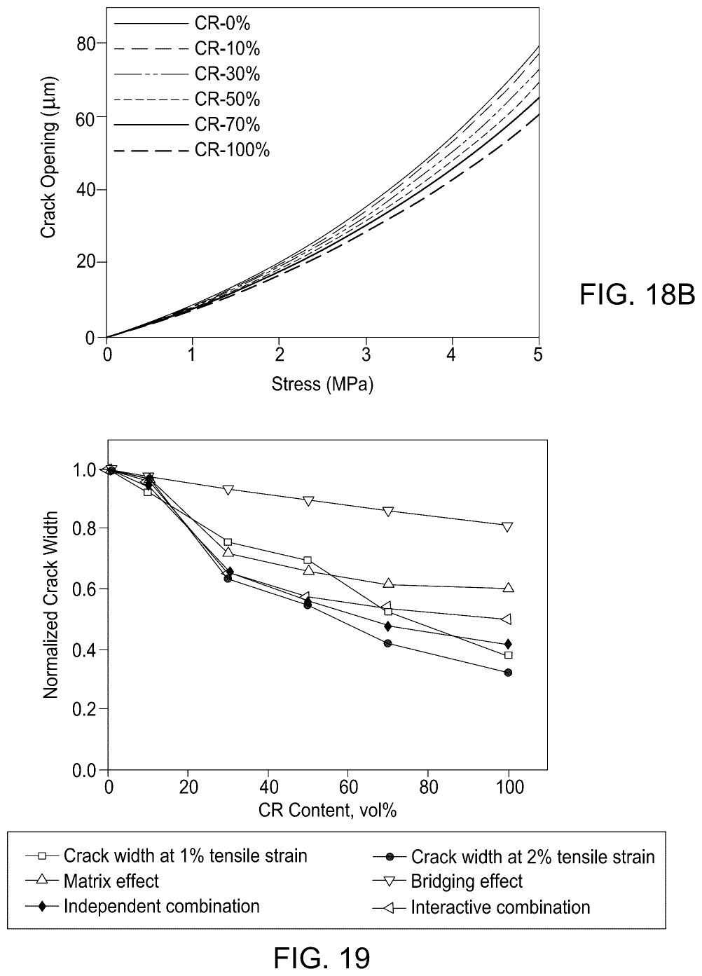

Since the tensile ductility for the samples is in the range of 2.2%-8.6%, the average crack width at 1% and 2% tensile strain are normalized to evaluate the effect of both rubber-weakened matrix and rubber bridging effects. For most compositions tested (FIG. 16), the stress level corresponding to strain in the range of 1% to 2% is in the range of 2-3 MPa. The crack width at 3 MPa (FIG. 18B) is shown in FIG. 19 as a function of CR content, normalized by that at non-CR addition (CR-0%). The influence of CR weakening the matrix is also shown in this figure. Both mechanisms of lowered matrix toughness and crack bridging by the presence of CR contribute to crack width reduction. The effect of bridging is not as strong as the weakened matrix effect, but each mechanism by itself appears inadequate to account for the crack reduction at high rubber content. Assuming independence between the two mechanisms, a simple superposition of their combined effect is shown in FIG. 19. This is consistent with the reduction trend of crack width at 1% and 2% tensile strain.

It might be more realistic that both effects are operating simultaneously. According to Eq. (10), the crack tip toughness Jₜᵢₚ can be calculated using the matrix properties, and the integral of the (σ_{ƒ}+σ_{CR})−δ curve can be computed as well (Eq. (10)). Thus, the matching point (σₛₛ, δₛₛ) can be identified. The normalized δₛₛ is also shown in FIG. 19, marked as the brown line, representing the interactive combined effect of the weakened matrix and crack bridging caused by CR.

From FIG. 19, the combined effects curves are consistent with the average crack width reduction, which confirms that the crack width reduction can be attributed to the combined effects of the rubber-weakened matrix and rubber bridging. It should be noted that the interactive combination curve is not as sharp as the independent combination curve at high rubber content, which can be explained by the increased slope of the stress-crack opening curve due to the rubber particle bridging, resulting in a smaller crack width reduction caused by the weakened matrix effect (FIG. 1A). Specifically, the slope of the stress-crack opening (σ−δ) curve increased with CR content due to the increased rubber bridging (FIG. 18). Thus, at a given reduced cracking stress caused by the weakened matrix effect, the crack width reduction at high CR content (>50%) is smaller than that of a low CR content, leading to a flattened crack reduction curve of interactive combinations.

### Parametric Analysis

The model predicted reduction in crack width by CR is highly related to the selection of parameters since the mechanical properties of rubber depend on the sources and use history. A parametric study can provide a deeper understanding of the effect of rubber on the crack width control of ECC, thus as a tool to design and tailor the properties of ECC. The following example is about the analysis of the parameters, including the physical properties of rubber (particle size distribution and elongation) and the defined parameter (α, β, and γ) in the model, with the case of rubber content of 100%.

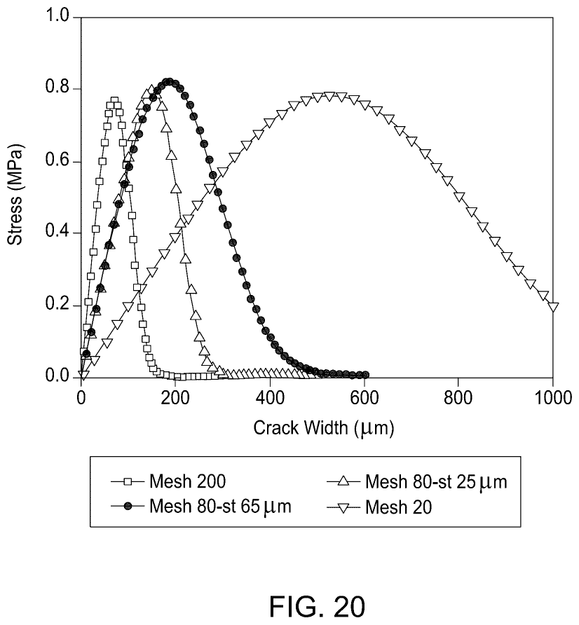

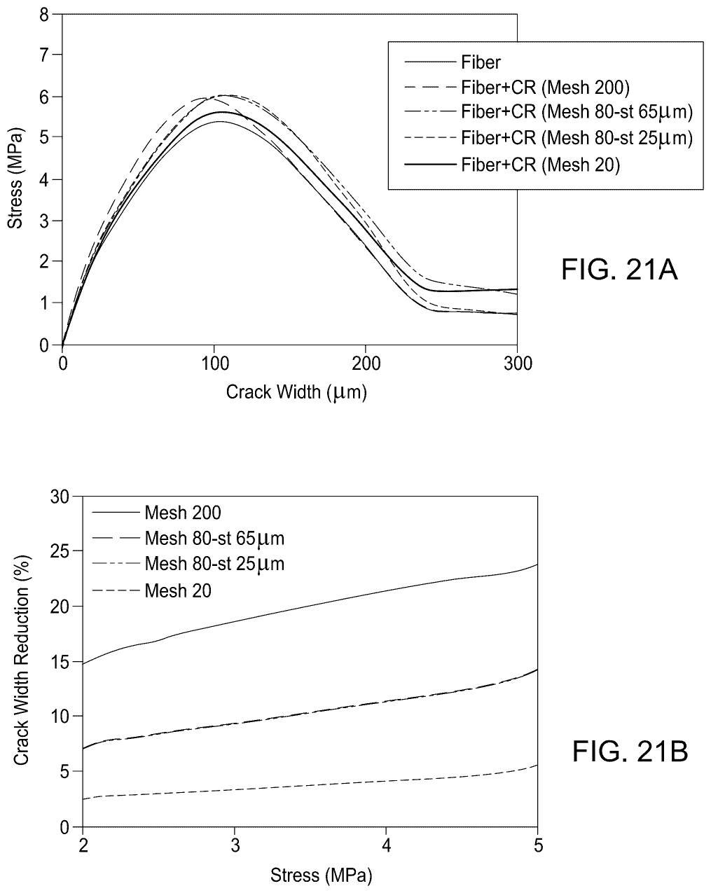

The impact of rubber particle size distribution on crack width (crack width control) is discussed herein. The discussed rubber particle sizes include Mesh 200, Mesh 80, and Mesh 20 with the average particle sizes of 51 μm, 125 μm, and 355 μm, respectively. Two different standard deviations (st), 65 μm and 25 μm for Mesh 80, are also compared. As shown in FIG. 20, the small particle size rubber shows strong bridging at small crack openings since the smaller size particles require more stretching, leading to stronger bridging stress. However, the early developed bridging stress cannot last long at the crack opening due to the limited deformation ability of small size particles. Specifically, the bridging stress of Mesh 200 reached the peak at the crack opening of 70 μm with 34.4% of rubber particles ruptured, while the corresponding rubber rupture ratio for Mesh 80 and Mesh 20 is only 3%-6%. This also leads to the difference in combined bridging stress (fiber+CR) and crack width reduction, as shown in FIGS. 21A-21B. Smaller particles show more obvious strength enhancement and crack width reduction than larger-size particles. For the cracking stress range of 2-3 MPa, Mesh 200 (51 μm) can reduce the crack width by 14.7%-18.6% compared to 2.5%-9.5% caused by Mesh 80 (125 μm) and Mesh 20 (355 μm).

For a narrow distribution range with a small standard deviation (Mesh 80-st 25 μm), the bridging stress increases at a slightly sharper rate than that with a large standard deviation (Mesh 80-st 65 μm) and reaches the peak stress at a smaller crack opening (FIG. 20). However, this difference has a negligible impact on the combined bridging stress and crack width reduction, as shown in FIGS. 21A-21B.

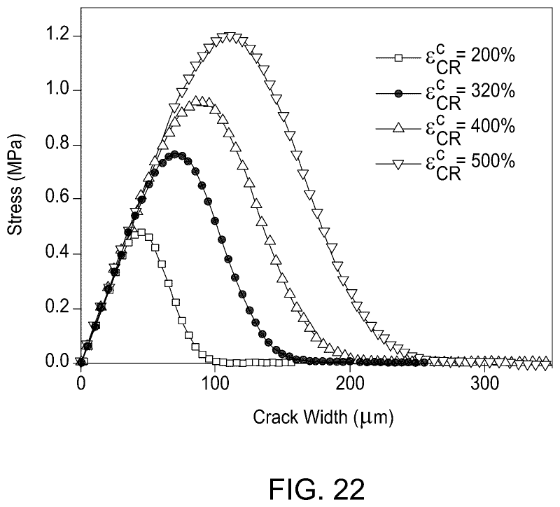

The effect of rubber elongation on crack width control is further investigated. As an elastomer, rubber has large elongation (ε_{CR}^{c}) and can stretch several times its original length. Depending on the rubber source, the rubber's typical elongation range is from 200% to 500%. The impact caused by elongation capacity variation is discussed herein. The elongation of rubber significantly influences the bridging stress as shown in FIG. 22. The rubber bridging stress for all ε_{CR}^{c} is almost the same linearly at lower crack openings, indicating a relatively low rubber rupture ratio. With the increased crack opening, the rubber particles with 200% elongation fail and rupture gradually due to limited tensile strain capacity. The linear increase of bridging stress ceased at the crack opening of 30 μm with a 12.2% rubber rupture ratio, followed by a slow increase to the peak stress at 45 μm with a 36.9% rubber rupture ratio. However, the other curves at the separation point still have low rupture ratios (3.7%, 2.3%, and 1.5% for the elongation of 320%, 400%, and 500%, respectively), and the stress increase remains linear. In addition, the rupture ratio for all the curves is in a similar range at the linear increase turning point (8-12%) and peak point (35-40%).

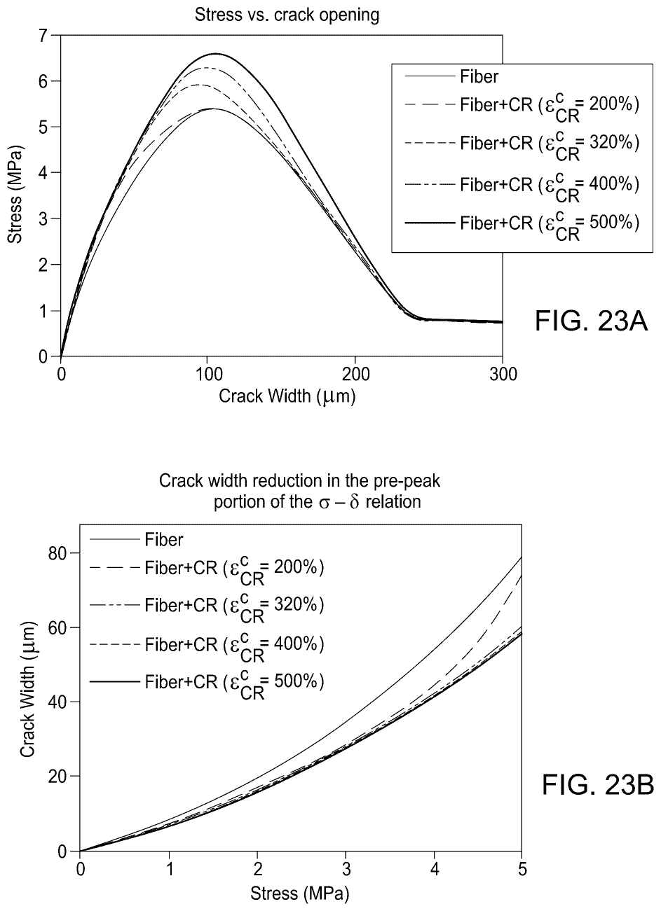

The total stress-crack width relations are shown in FIG. 23A. Since the rubber bridging stress of 200% elongation is too low (0.47 MPa) and nearly reduced to zero at the crack width of 100 μm, the stress enhancement by rubber bridging disappears after that crack width. As shown in FIG. 23B, for the cracking stress range (2-3 MPa), the crack width reduction for all elongations is the same since they share the same rubber bridging stress curve at the small corresponding crack opening.

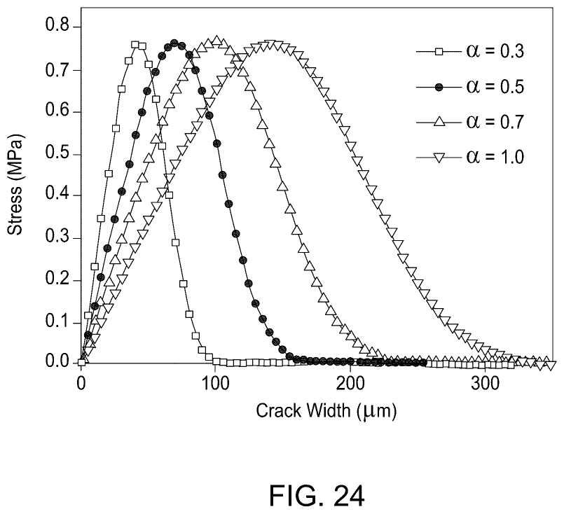

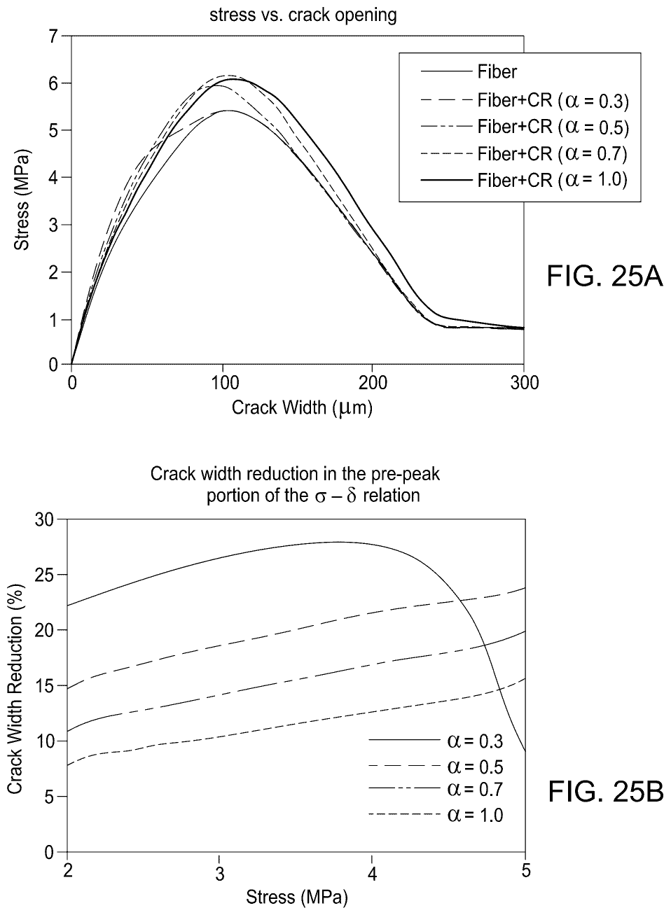

The effect of α on crack width control is also investigated. The debonded length L_{CR} is assumed as a ratio α to the particle size in the modeling and it is difficult to predict due to the irregular shape and size of the rubber particles. The impact of a on the rubber bridging is discussed herein. As shown in FIG. 24, the peak bridging stress for different debonded lengths remains the same due to the unchanged mechanical properties of rubber. However, the peak stress occurs earlier for a small a value. At a given crack opening, a smaller α value leads to smaller debonded length, requiring a larger deformation and thus larger rubber bridging stress. Specifically, the bridging stress of α=0.3 reaches the peak (0.76 MPa) at a crack opening of 40 μm, while for the ideal situation α=1.0, i.e., the whole rubber particle can be stretched with the crack opening, the bridging stress is only 37% of that at the same crack opening. This also results in the early strengthening of total bridging (fiber+rubber) stress at a small a value as shown in FIG. 25A. For α=0.3, the total bridging stress increase in a sharp slope due to the strong rubber bridging effect at small crack openings, but after rubber bridging reaches the peak at the crack width of 40 μm, the rubber bridging is exhausted, thus followed by a flattened branch. Further, the crack width of α=0.3 can be reduced by 22.3%-26.5% for the cracking stress range of 2-3 MPa, compared to 7.9%-18.6% at α=0.5-1.0 (FIG. 25B).

The effect of β on crack width control is also investigated herein. The participation rate β of rubber particles in the bridging effect is determined by micro-CT scanning. This value might vary with product sources and particle size distribution. The impact of this value on crack width control is discussed below.

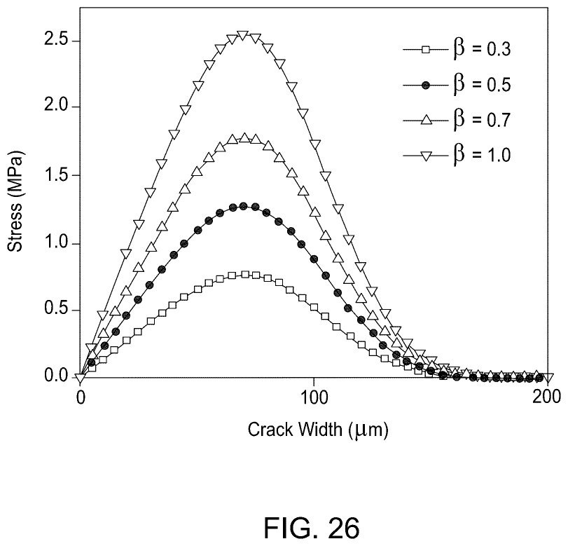

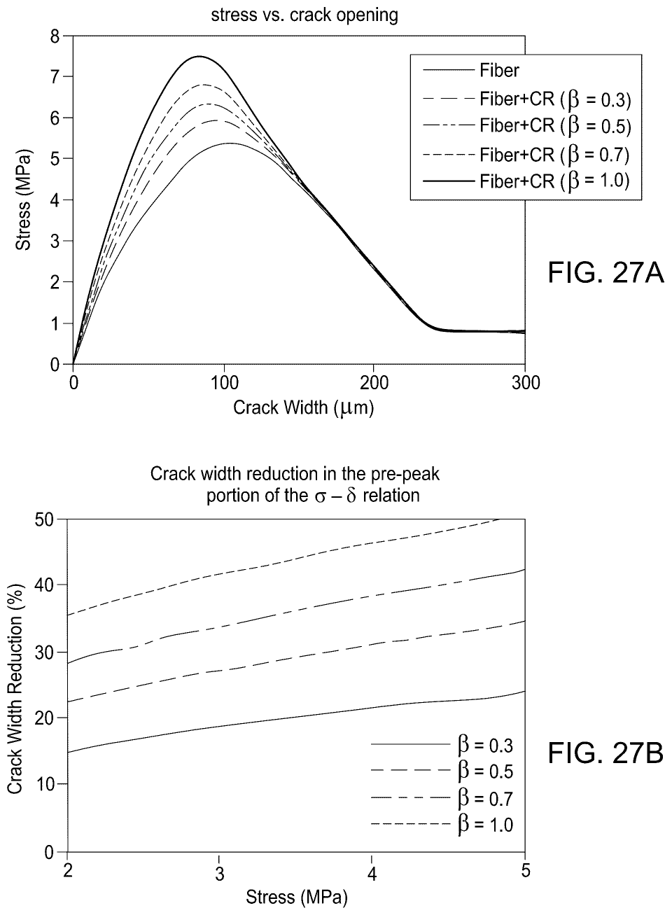

FIG. 26 shows the rubber bridging stress with varying δ. Similar to rubber content discussed above, β represents the effectiveness of rubber particle bridging in the matrix, so the high participation rate leads to high bridging stress. When all the rubber particles sustain and transfer stress (β=1), the bridging stress is as high as 2.54 MPa, 3.3 times that of the ratio (δ=0.3) used in the above discussion. Then the total bridging stress (fiber+CR) is increased by 39%, as shown in FIG. 27A. As shown in FIG. 27B, for the cracking stress range of 2-3 MPa, a total bridging (β=1) can reduce the crack width by 35.4%-41.6% compared to the situation discussed above (14.7%-18.5% for β=0.3).

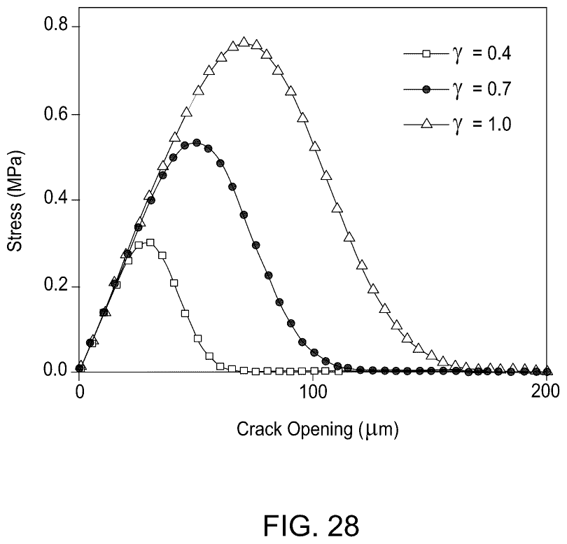

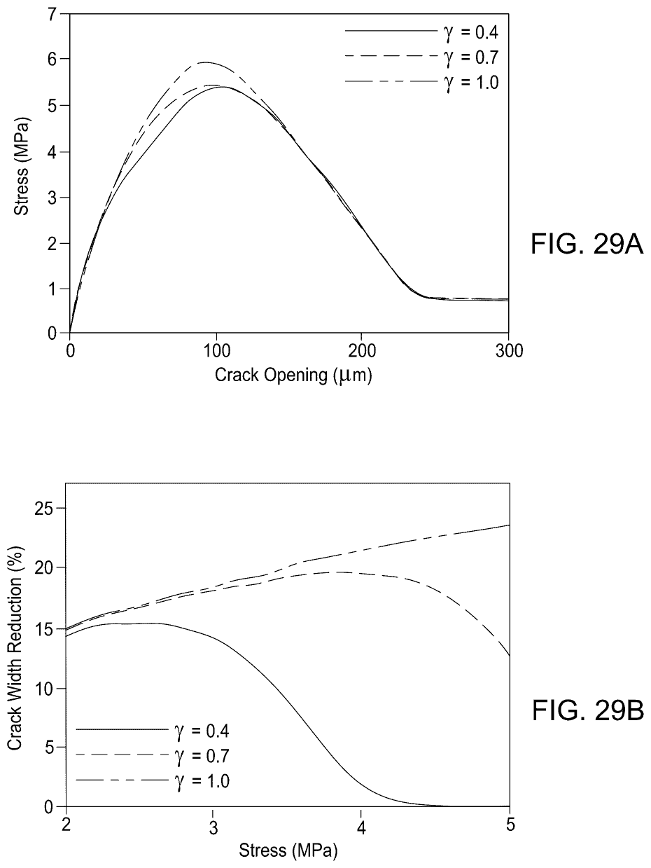

The effect of γ on crack width control is also investigated. Considering the use history and recycled process, the mechanical properties might deteriorate compared to the brand-new tire rubber. The effect of the knock-down factor γ on elongation is analyzed here. FIG. 28 indicates that with less elongation (decreasing γ), the rubber particle bridging is weakened, and also for the combined stress in FIG. 29A. When rubber elongation is reduced to 70% and 40% of the original value, the maximum bridging stress that rubber sustains is reduced by 30% and 61%, respectively. Accordingly, less elongation or deformation capacity leads to less contribution to the crack width control, as shown in FIG. 29B. The crack width reduction in the cracking stress range (2-3 MPa) is less affected when the elongation of rubber is reduced to 70% of the original value, but when γ is reduced further with a significant deterioration, the rubber particles rupture at a small deformation, resulting in a limited effect on the crack width reduction.

These experiments study the effects of crumb rubber (CR) particles on crack width control of ECC experimentally and further developed a micromechanical model to simulate and evaluate the crack bridging effect of CR. Through experimental investigation and theoretical analysis, the following conclusions can be drawn. The addition of a tire-derived crumb rubber (CR) reduced the matrix toughness and led to lowering the cracking stress and crack opening in an engineered cementitious composite (ECC) composition. Further, CR particles were found to link cracks and served as crack bridging elements. Micro-CT scans revealed this phenomenon and provided supportive evidence on the role CR played in enhancing multiple cracking of ECC. Microcrack propagation was hindered by CR particles in the matrix, resulting in observed crack deflection and scattering around rubber particles. Stretching of bridging CR particles was observed to restrain crack opening.

The observed crack width reduction in the presence of CR was found to result from a combination of reduced matrix toughness and crack bridging. Although the effect of CR bridging on crack width reduction is not as strong as the effect of the weakened matrix, each mechanism alone appears inadequate to account for the experimentally observed magnitude of crack width reduction. The two mechanisms were found to reduce crack width interactively.

The material properties of rubber impact the crack width control ability of ECC. High rubber content, small particle size, and narrow size distribution lead to a noticeable improvement in the bridging stress and crack width control. Parametric studies indicate that the debond length ratio (α) and bridging participation ratio (δ) of rubber can be treated as the “effective” rubber stretching particle size and content, thus leading to similar effects on crack width control. The elongation capacity of CR has a negligible impact on the crack width reduction due to the superior deformation ability as an elastomer. However, if the elongation of used rubber goes through a considerable deterioration, the crack width control ability can be diminished.

Based on these experimental and theoretical studies, the mechanisms of CR in crack width control of ductile ECC are clarified. These findings provide guidance on ECC composite design for a tight crack width using CR to develop an ECC with crack width less than 50 μm and extreme durability properties appears feasible.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. An engineered cementitious composite comprising:
a Portland cement binder;
a tire-derived rubber granular component;
a calcined clay component comprising a calcined clay, Portland cement component, and limestone;
water;
a superplasticizer; and
a polymeric or natural fiber,
wherein the engineered cementitious composite having a tensile strain capacity of greater than or equal to about 3% and an ultimate tensile strength of greater than or equal to about 2.2 MPa.

2. The engineered cementitious composite of claim 1, wherein the Portland cement binder is present at greater than or equal to about 20% by mass to less than or equal to about 26% by mass of the engineered cementitious composite.

3. The engineered cementitious composite of claim 2, wherein the Portland cement binder is present at greater than or equal to about 21% by mass to less than or equal to about 24% by mass of the engineered cementitious composite.

4. The engineered cementitious composite of claim 1, wherein the calcined clay component is present at greater than or equal to about 9% by mass to less than or equal to about 15% by mass of the engineered cementitious composite.

5. The engineered cementitious composite of claim 1, wherein the calcined clay component is present at greater than or equal to about 10.7% by mass to less than or equal to about 11.8% by mass of the engineered cementitious composite.

6. The engineered cementitious composite of claim 1, wherein the calcined clay comprises a metakaolin.

7. The engineered cementitious composite of claim 6, wherein the calcined clay component has a mass ratio of calcined clay to limestone of about 1:1.

8. The engineered cementitious composite of claim 1, wherein the tire-derived rubber granular component is present at greater than or equal to about 1.8% by mass to less than or equal to about 23% by mass of the engineered cementitious composite.

9. The engineered cementitious composite of claim 1, wherein the tire-derived rubber granular component is present at greater than or equal to about 5.6% by mass to less than or equal to about 14.5% by mass of the engineered cementitious composite.

10. The engineered cementitious composite of claim 1, wherein the tire-derived rubber granular component is a plurality of particles having an average particle size of greater than or equal to about 50 micrometers to less than or equal to about 200 micrometers.

11. The engineered cementitious composite of claim 1, wherein the superplasticizer is present at greater than or equal to about 0.26% to less than or equal to about 0.33% by the mass of engineered cementitious composite.

12. The engineered cementitious composite of claim 1, wherein the polymeric or natural fiber comprises polyalkylene fibers present at greater than 1 volume % to less than or equal to about 3 volume % of the engineered cementitious composite.

13. The engineered cementitious composite of claim 1, wherein the water is present at present at greater than or equal to about 19% by mass to less than or equal to about 31% by mass and the superplasticizer is present at greater than or equal to about 0.26% to less than or equal to about 0.33% by the mass of engineered cementitious composite.

14. The engineered cementitious composite of claim 1, further comprising an additive selected from the group consisting of: silica sand, fly ash, a cellulose-based viscosity modifier, microsilica, and combinations thereof.

15. The engineered cementitious composite of claim 1, further comprising an additive selected from the group consisting of:
silica sand present at greater than 0% by mass to less than or equal to about 17% by mass of the engineered cementitious composite;
fly ash present at greater than 0% by mass to less than or equal to about 40% by mass of the engineered cementitious composite;
a cellulose-based viscosity modifier present at greater than 0.05% to less than or equal to about 0.1% by mass of binders present in the engineered cementitious composite, wherein the binders comprise the Portland cement binder, the calcined clay component, and any fly ash;
microsilica present at greater than 0% by mass to less than or equal to about 5% by mass of the engineered cementitious composite; and
combinations thereof.

16. An engineered cementitious composite comprising:
Portland cement binder at greater than or equal to about 20% by mass to less than or equal to about 26% by mass of the engineered cementitious composite;
a tire-derived rubber granular component at greater than or equal to about 1.8% by mass to less than or equal to about 23% by mass of the engineered cementitious composite;
a calcined clay component comprising a calcined clay, Portland cement component, and limestone at greater than or equal to about 9% by mass to less than or equal to about 15% by mass of the engineered cementitious composite;
water at greater than or equal to about 19% by mass to less than or equal to about 31% by mass;
a superplasticizer at greater than or equal to about 0.26 to less than or equal to about 0.33% by the mass of engineered cementitious composite; and
a polymeric or natural fiber at greater than or equal to about 1% by volume to less than or equal to about 2% by volume,
wherein the engineered cementitious composite has a tensile strain capacity of greater than or equal to about 3% and an ultimate tensile strength of greater than or equal to about 2.2 MPa.

17. The engineered cementitious composite of claim 16, further comprising an additive selected from the group consisting of: silica sand, fly ash, a cellulose-based viscosity modifier, microsilica, and combinations thereof.

18. The engineered cementitious composite of claim 16, further comprising an additive selected from the group consisting of:
silica sand present at greater than 0% by mass to less than or equal to about 17% by mass of the engineered cementitious composite;
fly ash present at greater than 0% by mass to less than or equal to about 40% by mass of the engineered cementitious composite;
a cellulose-based viscosity modifier present at greater than 0.05% to less than or equal to about 0.1% by mass of binders present in the engineered cementitious composite, wherein the binders comprise the Portland cement, the calcined clay component, and any fly ash;
microsilica present at greater than 0% by mass to less than or equal to about 5% by mass of the engineered cementitious composite; and
combinations thereof.

19. The engineered cementitious composite of claim 16, wherein the calcined clay component has a mass ratio of calcined clay to limestone of about 1:1 and the calcined clay comprises a metakaolin.

20. The engineered cementitious composite of claim 16, wherein the tire-derived granular rubber component is a plurality of tire-derived particles having an average particles size of greater than or equal to about 50 micrometers to less than or equal to about 200 micrometers.

21. An engineered cementitious composite comprising:
a Portland cement binder at greater than or equal to about 21% by mass to less than or equal to about 24% by mass of the engineered cementitious composite;
a tire-derived rubber granular component at greater than or equal to about 5% by mass to less than or equal to about 15% by mass of the engineered cementitious composite;
a calcined clay component comprising a calcined clay, a Portland cement binder, and limestone at greater than or equal to about 10% by mass to less than or equal to about 12% by mass of the engineered cementitious composite;
water at greater than or equal to about 27% by mass to less than or equal to about 31% by mass;
a superplasticizer at greater than or equal to about 0.26% to less than or equal to about 0.33% by the mass of engineered cementitious composite;
a polymeric or natural fiber at greater than or equal to about 1% by volume to less than or equal to about 2% by volume;
silica sand present at greater than 0% by mass to less than or equal to about 17% by mass of the engineered cementitious composite;
fly ash present at greater than 14% by mass to less than or equal to about 30% by mass of the engineered cementitious composite;
a cellulose-based viscosity modifier present at greater than 0.05% to less than or equal to about 0.1% by mass of binders present in the engineered cementitious composite, wherein the binders comprise the Portland cement binder, the calcined clay component, and the fly ash;
microsilica present at greater than 0% by mass to less than or equal to about 5% by mass of the engineered cementitious composite;
wherein the engineered cementitious composite has a tensile strain capacity of greater than or equal to about 7% and an ultimate tensile strength of greater than or equal to about 3.5 MPa.
